(19) United States
(12) Patent Application Publication
(10) Pub. No.: US 2025/0284957 A1
(43) Pub. Date: Sep. 11, 2025

(54) LEARNING DEVICE, LEARNING SYSTEM, LEARNING METHOD

(71) Applicant: NEC Corporation, Tokyo (JP)

(72) Inventors: Takeo HOSOMI, Tokyo (JP); Yusuke Sakemi, Chiba (JP)

(73) Assignee: NEC Corporation, Tokyo (JP)

(21) Appl. No.: 19/049,220

(22) Filed: Feb. 10, 2025

(30) Foreign Application Priority Data
Mar. 6, 2024 (JP) 2024-034427

(51) Int. Cl. G06N 3/08; G06N 3/049

(52) U.S. Cl. CPC G06N 3/08; G06N 3/049

(57) ABSTRACT

A learning device performs learning a spiking neural network using time-to-first-spike coding, by using an evaluation function including a predetermined reference time given to each layer of the spiking neural network and an index related to neurons.

This application is based upon and claims the benefit of priority from Japanese patent application No. 2024-034427, filed Mar. 6, 2024, the disclose of which is incorporated herein in its entirety by reference.

### TECHNICAL FIELD

The present disclosure relates to a learning device, a learning system, a learning method, and a non-transitory storage medium.

### BACKGROUND ART

A spiking neural network is a type of neural network.

For example, Japanese Unexamined Patent Application, First Publication No. 2017-134821 describes that in a spiking neural network, in order to prevent neuron instability that may occur due to a very small membrane potential threshold, when the membrane potential of a neuron is smaller than a reference value, the synaptic weight for each neuron is increased instead of lowering the membrane potential of the neuron.

### SUMMARY

An example of an objective of the present disclosure is to provide a learning device, a learning system, a learning method, and a program that can solve the above-mentioned problems.

According to a first aspect of the present disclosure, a learning device is provided with a learning means for learning a spiking neural network using time-to-first-spike coding, by using an evaluation function including a predetermined reference time given to each layer of the spiking neural network and an index related to neurons.

According to a second aspect of the present disclosure, a learning system is provided with a spiking neural network using time-to-first-spike coding and a learning device, wherein the learning device is provided with a learning means for learning the spiking neural network using an evaluation function including a predetermined reference time given to each layer of the spiking neural network and an index related to neurons.

According to a third aspect of the present disclosure, a learning method includes learning, by a computer, a spiking neural network using time-to-first-spike coding, by using an evaluation function including a predetermined reference time given to each layer of the spiking neural network and an index related to neurons.

According to a fourth aspect of the present disclosure, a non-transitory storage medium that stores a program is one that causes a computer to execute processes, the processes including learning a spiking neural network using time-to-first-spike coding, by using an evaluation function including a predetermined reference time given to each layer of the spiking neural network and an index related to neurons.

### BRIEF DESCRIPTION OF THE DRAWINGS

FIG. 1 illustrates an example of a configuration of a learning system according to at least one embodiment.

FIG. 2 illustrates an example of a configuration of a neural network in accordance with at least one embodiment.

FIG. 3 is a diagram illustrating an example of a configuration of a convolutional layer included in the neural network according to at least one embodiment.

FIG. 4 illustrates an example of a correspondence between input data and output data in a convolutional channel according to at least one embodiment.

FIG. 5 illustrates an example of a configuration of a pooling layer in a neural network according to at least one embodiment.

FIG. 6 illustrates an example of a correspondence between input data and output data in a pooling channel according to at least one embodiment.

FIG. 7 illustrates an example of a configuration of a fully connected layer in a neural network according to at least one embodiment.

FIG. 8 illustrates an example of a configuration of an output layer in accordance with at least one embodiment.

FIG. 9 illustrates an example of a configuration of a learning device according to at least one embodiment.

FIG. 10 illustrates a first example of a neural network configuration used in an experiment according to at least one embodiment.

FIG. 11 illustrates a first example of neuron firing in a neural network in an experiment according to at least one embodiment.

FIG. 12 illustrates a second example of neuron firing in a neural network in an experiment according to at least one embodiment.

FIG. 13 illustrates a second example of a neural network configuration used in an experiment according to at least one embodiment.

FIG. 14 illustrates a third example of neuron firing in a neural network in an experiment according to at least one embodiment.

FIG. 15 illustrates a fourth example of neuron firing in a neural network in an experiment according to at least one embodiment.

FIG. 16 illustrates an example of a configuration of a learning device according to at least one embodiment.

FIG. 17 is a diagram illustrating an example of a spiking neural network according to at least one embodiment.

FIG. 18 illustrates another example configuration of a learning system according to at least one embodiment.

FIG. 19 is a diagram illustrating an example of a processing procedure in a learning method according to at least one embodiment.

FIG. 20 is a diagram illustrating a computer configuration in accordance with at least one embodiment.

### EXAMPLE EMBODIMENTS

Hereinbelow, preferred embodiments of the present disclosure will be described, but the disclosure according to the claims is not limited to the following embodiments. Furthermore, not all of the combinations of features described in embodiments are necessarily essential to the solutions of the disclosure.

### First Embodiment

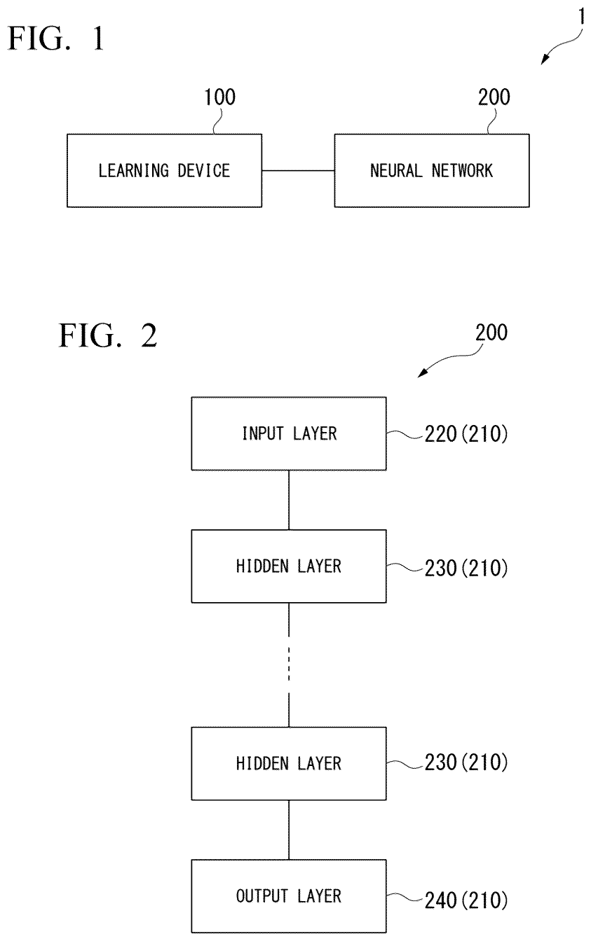

FIG. 1 is a diagram illustrating an example of a configuration of a learning system according to at least one embodiment. In the configuration shown in FIG. 1, the learning system 1 is provided with a learning device 100 and a neural network 200.

The learning system 1 is a system that performs learning of a neural network 200.

The neural network 200 is a neural network that is the subject of learning in the learning system 1, and is configured as a spiking neural network (SNN) using time-to-first-spike coding.

The term “learning a neural network” used here means adjusting the parameter values of the neural network using training data. Learning of a neural network can also be called training of a neural network.

Hereinbelow, the timing related to the operation of the neural network 200 will also be referred to as time. In this case, the “time” can be expressed, for example, as the time that has elapsed since neural network 200 started processing (the time that has elapsed since a signal was input to the neural network 200).

A spiking neural network is a neural network that comprises spiking neurons. A spiking neuron is a neuron that has an internal state called a membrane potential, and whose membrane potential changes depending on the input time of a spike signal or a signal called a spike (the firing time of a spiking neuron in the previous layer) and the parameter value, also called a weight, corresponding to each input. A spiking neuron outputs a spike signal when the membrane potential reaches a certain threshold. The output of a spike signal from a spiking neuron is also referred to as a firing. The timing at which a spiking neuron fires is also called the firing time. The threshold in this case is also called the firing threshold.

The change in membrane potential can be thought of as the calculation of the firing time by a spiking neuron.

A spiking neural network using time-to-first-spike coding is a spiking neural network that transmits information by firing times. In a spiking neural network using time-to-first-spike coding, each spiking neuron requires to fire at most once, and in this respect, power consumption can be made relatively small.

In the following, an example will be described in which the neural network 200 is configured as a Convolutional Neural Network (CNN) using spiking neurons. A convolutional neural network that uses spiking neurons is also called a spiking convolutional neural network.

A spiking convolutional neural network can be considered as a neural network that uses spike signals to perform the processing that a convolutional neural network does. Each layer of a spiking convolutional neural network can be considered as a layer that uses spike signals to perform the processing that each layer of the convolutional neural network performs.

However, the application of the learning device 100 is not limited to spiking convolutional neural networks. The learning device 100 can be applied to a variety of neural networks that include spiking neurons that transmit signals in a time-to-first-spike coding manner.

The process performed by the neural network 200 is also called estimation. Alternatively, the process performed by neural network 200 can be called prediction or forecasting. However, the target of processing performed by the neural network 200 is not limited to future events.

The functions of the neural network 200 may be performed by computer simulation. Alternatively, the neural network 200 may be implemented in hardware.

For example, during learning, the functions of the neural network 200 may be performed by a computer simulation. Then, based on the learning results, the neural network 200 may be implemented in hardware as a circuit using resistors, capacitors, etc., and used for operation.

FIG. 2 is a diagram showing an example of the configuration of the neural network 200. In the example of FIG. 2, the neural network 200 is configured as a feedforward neural network and includes an input layer 220, one or more hidden layers 230, and an output layer 240. The layers of neural network 200 are also referred to as layers 210.

The neural network 200 may include layers 210 that do not include spiking neurons (i.e., layers 210 that are configured without spiking neurons). When a layer 210 that does not have spiking neurons outputs a spike signal, this is also referred to as firing. The time at which the layer 210 that does not include spiking neurons outputs a spike signal is also referred to as a firing time.

The time at which a spike signal is output is also referred to as the firing time of the spike signal.

The layer 210 may include a number of channels. The channel here refers to a path for a signal. More specifically, the channels referred to here are divisions of the layer 210 according to signal paths. If the layer 210 comprises multiple channels, each channel performs processing on the signal independent of the other channels. Specifically, each channel in the same layer 210 receives the same signal as input, and processes it using different weights for each channel.

The number of elements of the spike signal output by each channel is also called the dimension number of that channel. For example, if a channel outputs a signal in which spike signals are arranged in the form of a matrix, the number of elements of the matrix corresponds to the number of dimensions of the channel.

The matrix of spike signals is also called a spike matrix. In the following, the tensor of spike signals will also be referred to as a spike matrix.

The input layer 220 accepts input of two-dimensional data, such as image data, and outputs a spike matrix of the same size as the input data. For each element of the input data, the input layer 220 outputs a spike signal at a firing time according to the value of that element.

However, the dimensions of data that the input layer 220 accepts as input are not limited to two dimensions. For example, the input layer 220 may be configured to accept input of three or more dimensional data. Alternatively, the input layer 220 may accept input of one-dimensional data.

The input layer 220 may include a spiking neuron for each element of the input data, and the membrane potential may increase in proportion to the magnitude of the element value of the input data. In this case, the input layer 220 outputs a spike signal earlier for each element of the input data as the element value increases.

However, the relationship between the size of the elements of the input data and the timing at which the input layer 220 outputs a spike signal is not limited to a specific relationship. For example, the input layer 220 may be configured to output a spike signal earlier for each element of the input data as the element value becomes smaller. The input layer 220 may be constructed without using spiking neurons.

Each hidden layer 230 receives spike signals as input from the previous layer 210 and outputs spike signals according to the input situation, depending on the input time of the spike signal (the firing time of the spiking neuron in the previous layer) and the value of the weight (weighting coefficient) corresponding to each input.

Each hidden layer 230 of the neural network 200 is configured from a convolutional layer, a pooling layer, a fully connected layer, and the like. For example, the hidden layer 230 may be comprised of a convolutional layer, a combination of convolutional and pooling layers, or a fully connected layer.

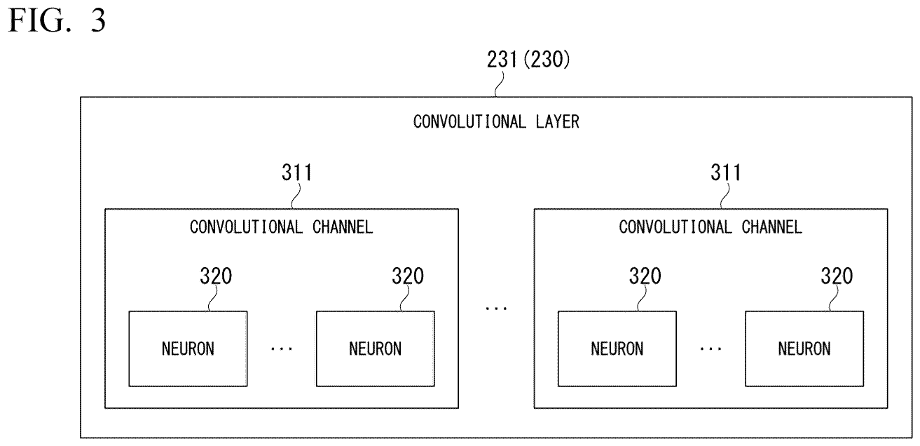

FIG. 3 is a diagram showing an example of the configuration of a convolutional layer included in the neural network 200. In the configuration of FIG. 3, the convolutional layer 231 comprises one or more convolution channels 311. The convolutional channel 311 comprises one or more neurons 320.

The convolutional channel 311 is a channel of the convolutional layer 231. Each convolution channel receives an input of a spike matrix, processes the signal, and outputs a spike matrix. The spike matrix output by the convolution channel 311 can be thought of as a feature map.

The neuron 320 is a spiking neuron.

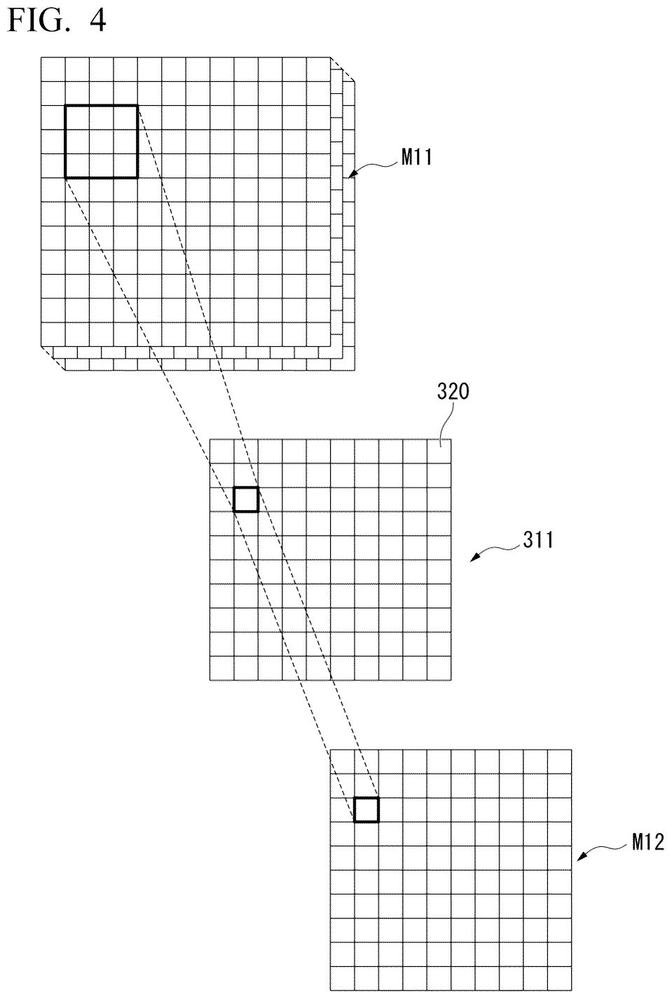

FIG. 4 is a diagram showing an example of the correspondence between input data and output data in the convolution channel 311. In the example of FIG. 4, the convolution channel 311 is provided with neurons 320 corresponding to the elements of the spike matrix M12, which is the output data of the convolution channel 311 itself. Therefore, the dimensionality of a channel of a convolutional layer 231 is equal to the number of neurons 320 per channel in that convolutional layer 231.

The convolution channel 311 receives as input the output data from each channel of the previous layer. When the output data from each channel in the previous layer is represented as a two-dimensional spike matrix, the input data to the convolution channel 311 can be regarded as a two-dimensional spike matrix equal to the number of channels in the previous layer, or as a single three-dimensional spike matrix.

Each neuron 320 receives the spike signal of an element corresponding to the position referenced by the kernel of the convolutional neural network among the elements of the spike matrix M11 from each channel of the previous layer, which is the input data to the convolutional channel 311. Then, in each neuron 320, the membrane potential changes according to the convolution equation. For example, the membrane potential of the neuron 320 of the convolutional channel 311 may be changed according to Equation (1).

$$\begin{matrix}[ Equation 1 ] & \\ \frac{d}{dt} {v}_{i}^{( l )} ( t ) = {\sum }_{j ∈ {j}_{i}^{( l )}} {W}_{j}^{( l )} θ ( t - {t}_{j}^{( l - 1 )} ) & ( 1 )\end{matrix}$$

Equation (1) shows an example for the i-th neuron 320 in the l-th layer. Here, l denotes an identification number that identifies the layer 210 of the neural network 200. Here, i denotes an identification number that identifies a neuron 320 in the l-th layer.

The identification numbers of the layers 210 are assigned in order from the upstream side of the flow of the spike signal. Therefore, the smaller the identification number of a layer 210, the more upstream the layer 210 is located in the flow of spike signals.

v^{(l)}ᵢ(t) denotes the membrane potential of the i-th neuron 320 in the l-th layer at time t.

j indicates an identification number that identifies a spike signal that can be output from the l−1th layer. When the l−1th layer is a layer in which the neuron 320 outputs a spike signal, j can be an identification number that identifies the neuron 320 in the l−1th layer.

Here, “there is a possibility” means that among the spike signals identified by the identification numbers, there may be spike signals that are not output. For example, among the neurons 320 included in the convolutional channel 311, there may be neurons 320 whose membrane potential does not reach a threshold and therefore do not fire.

If the firing time of a neuron 320 cannot be determined because the neuron 320 does not fire, causing problems in the calculation, the firing time of the neuron 320 may be set and the calculation may be performed. For example, the learning portion 191 may perform calculations in learning the neural network 200 by setting the firing time of a neuron 320 that is not firing to a time that is predetermined as being sufficiently later than the time at which the neuron 320 is expected to fire.

J^{(l)}ᵢ indicates a set of spike signal identification numbers referenced by the i-th neuron 320 in the l-th layer, among the identification numbers of spike signals that may be output from the l−1th layer. The spike signal referred to by the i-th neuron 320 in the l-th layer here is the spike signal of the element in the spike matrix M11 described above that corresponds to the position referred to by the kernel of the convolutional neural network.

W^{(l)}ⱼ indicates a weighting coefficient in the l-th layer neuron 320 for the j-th spike signal that may be output from the l−1th layer. The weighting coefficient W^{(l)}ⱼ is a learning target in the learning of the neural network 200 performed by the learning device 100. That is, the value of the weighting coefficient W^{(l)}ⱼ is subject to updating during the learning of the neural network 200 performed by the learning device 100.

θ represents a step function, and is expressed as in Equation (2).

$$\begin{matrix}[ Equation 2 ] & \\ θ ( x ) = \{ \begin{matrix}0 & ( when x < 0 ) \\ 1 & ( when x \geq 0 )\end{matrix} & ( 2 )\end{matrix}$$

t^{(l-1)}ⱼ indicates the firing time of the j-th spike signal that may be output from the l−1-th layer. When spike signals are differentiated by channel, the firing time of an i-th spike signal that may be output from the c-th channel of the l-th layer is also represented as t^{(l)}_{c,j}.

However, the change in the membrane potential of the neuron 320 is not limited to that shown in Equation (1).

The neuron 320 fires when the membrane potential reaches a threshold. Each neuron 320, upon firing, outputs a spike signal, which becomes one element of the spike matrix M12.

The neuron 320 may further use an activation function to calculate firing times. For example, the neuron 320 may be configured by connecting two spiking neurons in series. Then, the membrane potential of the spiking neuron on the front side (upstream side of the signal flow) may change according to the convolution equation as described above, and the spiking neuron may fire when the membrane potential reaches a threshold value. In addition, when a spiking neuron on the rear side (downstream in the signal flow) receives a spike input from a spiking neuron on the front side, the membrane potential of the spiking neuron on the rear side may be changed according to the equation of the activation function. Then, when the membrane potential reaches a threshold, the rear spiking neuron may fire.

For each layer 210 of the neural network 200 that includes neurons 320, such as the convolutional layer 231, a time period during which the firing time of the neurons 320 in that layer 210 is transmitted to the next layer may be set. This time period is also called the firing time period. By setting the firing time period, in subsequent layers 210 (layers 210 located downstream in the signal flow), neurons 320 that do not fire within the firing time period can be processed as if they did not fire.

In this way, by setting the firing time period, it is possible to clearly determine for each hidden layer 230 how long to wait for the input of a spike signal. This allows the neural network 200 to newly process different input data before the neurons in the output layer fire. In other words, pipeline operation of the neural network 200 becomes possible, leading to improved throughput.

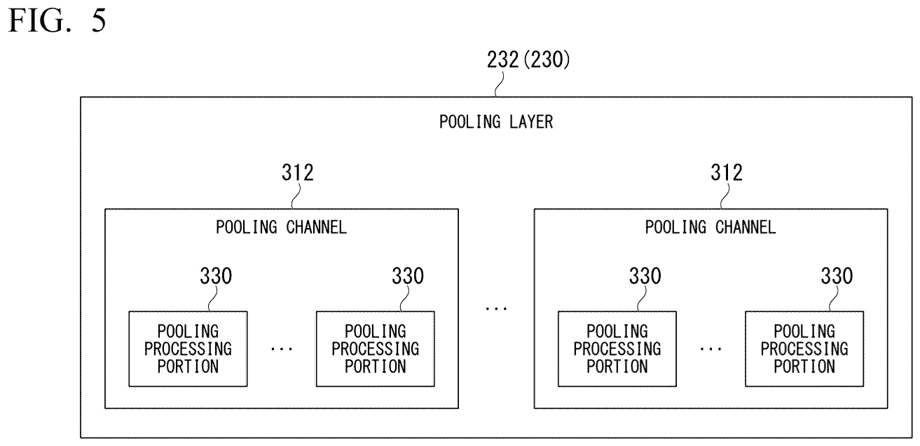

FIG. 5 is a diagram showing an example of the configuration of a pooling layer included in the neural network 200. In the arrangement of FIG. 5, the pooling layer 232 comprises one or more pooling channels 312. The pooling channel 312 includes one or more pooling processing portions 330.

The pooling channel 312 is a channel of the pooling layer 232.

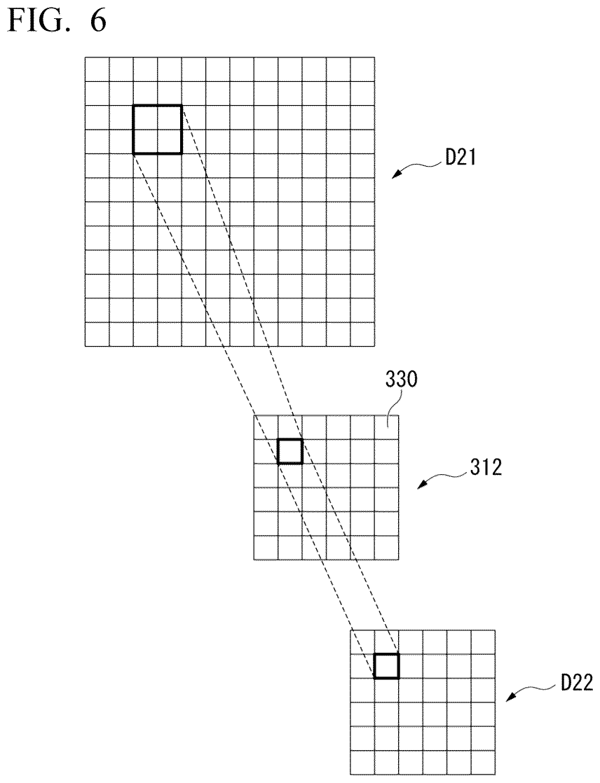

FIG. 6 is a diagram showing an example of the correspondence between input data and output data in the pooling channel 312. In the example of FIG. 6, the pooling channel 312 includes a pooling processing portion 330 corresponding to each element of the spike matrix M22, which is the output data of the pooling channel 312 itself. Therefore, the number of dimensions of the channels of the pooling layer 232 is equal to the number of pooling processing portions 330 per channel in the pooling layer 232.

Each of the pooling processing portions 330 receives the input of spike signals of elements of the spike matrix M21, which is the input data to the pooling channel 312, that are included in a window determined for each pooling processing portion 330 (i.e., for each element of the spike matrix M22). The spike signals of the elements included in the pooling window are also referred to as the spike signals included in the pooling window.

Each of the pooling processing portions 330 outputs one spike signal in response to the input spike signals.

As a result, the pooling channel 312 outputs a feature map that is a downsampled version of the input feature map. In the case of FIG. 6, the spike matrix M21 corresponds to an example of a feature map input to the pooling channel 312. The spike matrix M22 is an example of a feature map output by the pooling channel 312.

For example, in the case where a spike signal indicates a larger value the earlier the firing time, max pooling is performed by the pooling processing portion 330 firing at a firing time corresponding to the earliest firing time among the firing times of the input spike signals. The pooling in this case can also be considered as mini pooling if we focus on the firing time.

In this case, the pooling processing portion 330 may output the spike signal that first reaches the pooling processing portion 330 as is.

In this way, the pooling processing portion 330 may output a spike signal at a timing corresponding to the timing at which it receives input of any one of the spike signals included in the window. This allows the pooling processing portion 330 to output spike signals without the need to calculate firing times, such as calculating firing times using membrane potentials.

This allows the pooling layer 232 to output data relatively quickly. In particular, for the pooling layer 232, there is no need to provide a firing time period. In this regard, it is expected that the neural network 200 will be able to perform inferences in a relatively short time.

However, the pooling method performed by the pooling channel 312 is not limited to the above method. For example, the pooling channel 312 may perform average pooling.

When the pooling processing portion 330 calculates the firing time, the pooling processing portion 330 may be configured using the neurons 320. In this case, when the neuron 320 receives an input of a spike signal, the membrane potential may be changed according to the pooling method. Then, when the membrane potential reaches a threshold, the neuron 320 may fire. Alternatively, a step function may be used as the spike signal, which indicates a level change that maintains a value of 0 (OFF) before firing and a value of 1 (ON) after firing. Then, mini pooling, which propagates the earliest firing spike, may be implemented using an OR circuit.

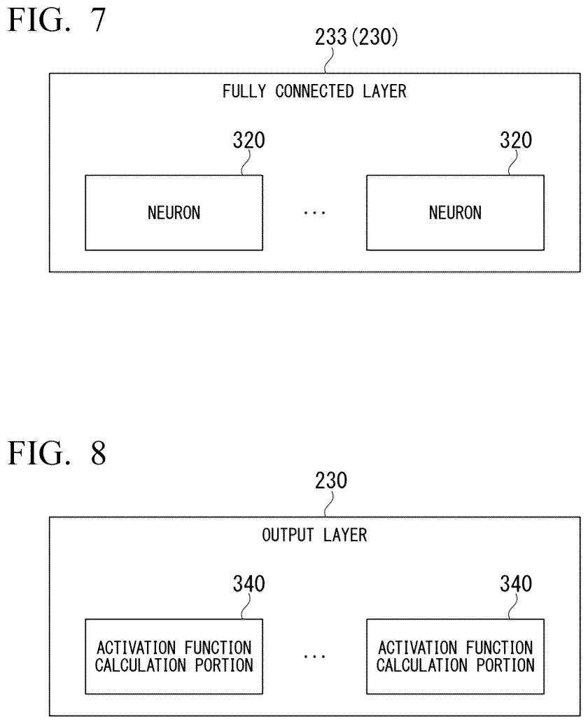

FIG. 7 is a diagram showing an example of the configuration of a fully connected layer included in the neural network 200. In the configuration of FIG. 7, the fully connected layer 233 is provided with one or more neurons 320.

Each neuron 320 in the fully connected layer 233 receives spike signals as input from all neurons 320 in the previous layer 210, and outputs at most one spike signal.

For the fully connected layer, the number of channels is set to 1. Thus, the dimensionality of the channels of a fully connected layer is equal to the number of neurons 320 in that layer.

FIG. 8 is a diagram showing an example of the configuration of the output layer 240. In the configuration of FIG. 8, the output layer 240 includes one or more activation function calculation portions 340.

The activation function calculation portion 340 calculates the activation function. The activation function calculation portion 340 may be configured using the neurons 320. In this case, when the neuron 320 receives an input of a spike signal, the membrane potential may be changed according to an activation function. Then, when the membrane potential reaches a threshold, the neuron 320 may fire. However, the configuration of the activation function calculation portion 340 is not limited to the configuration using the neurons 320.

The neural network 200 does not necessarily have to include the output layer 240. In this case, the output of the last hidden layer 230 may be used as the output of the neural network 200.

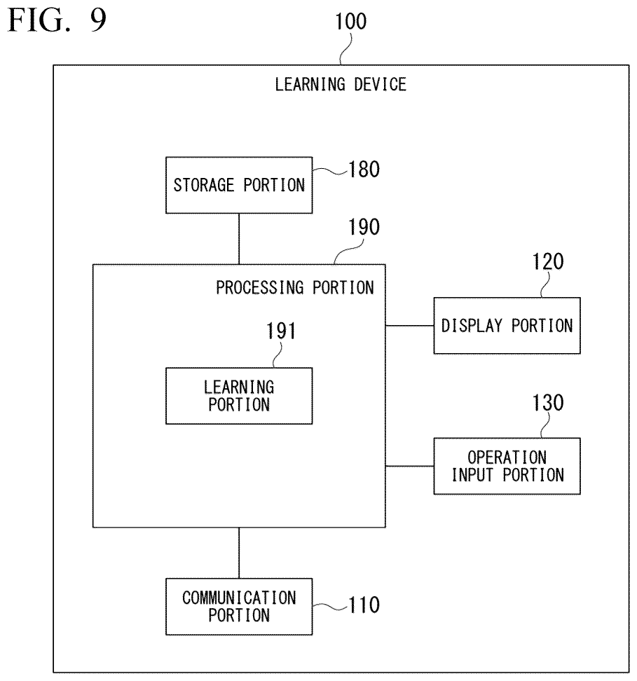

FIG. 9 is a diagram illustrating an example of the configuration of the learning device 100. In the configuration shown in FIG. 9, the learning device 100 is provided with a communication portion 110, a display portion 120, an operation input portion 130, a storage portion 180, and a processing portion 190. The processing portion 190 includes a learning portion 191.

The learning device 100 performs learning on the neural network 200. The learning device 100 may be configured using a computer. When the functions of the neural network 200 are executed by simulation using a computer, the learning device 100 and the neural network 200 may be configured using the same computer.

The communication portion 110 communicates with other devices. For example, the communication portion 110 may receive the training data from a device that stores the training data. When the learning device 100 and the neural network 200 are configured as separate devices, the learning device 100 may transmit and receive various data for learning between the learning device 100 and the neural network 200.

The display portion 120 has a display screen, such as a liquid crystal panel or an LED (Light Emitting Diode) panel, and acquires various images. For example, the display portion 120 may display various information related to the learning of the neural network 200, such as the progress of the learning of the neural network 200 and the accuracy rate of the estimation performed by the neural network 200.

The operation input portion 130 includes input devices such as a keyboard and a mouse, and receives user operations. For example, the operation input portion 130 may receive a user operation for making various settings related to the learning of the neural network 200, such as a user operation for setting a learning rate.

The storage portion 180 stores various types of data. For example, the storage portion 180 may store the training data. Furthermore, when the functions of the neural network 200 are executed by a simulation using a computer that constitutes the learning device 100, the storage portion 180 may be configured to store a simulation model of the neural network 200. The storage portion 180 is configured using a storage device provided in the learning device 100.

The processing portion 190 controls each unit of the learning device 100 to perform various processes. The functions of the processing portion 190 are performed, for example, by a CPU (Central Processing Unit) included in the learning device 100 reading and executing a program from the storage portion 180.

The learning portion 191 performs learning on the neural network 200. In particular, the learning portion 191 performs learning of the neural network 200 using an evaluation function that includes a predetermined time and an index related to the neuron 320.

The learning portion 191 corresponds to an example of a learning means.

The predetermined time here is also called a reference time. The reference time is set for each layer 210 that is the subject of learning of the neural network 200. If a firing time period is set for the layer 210, the reference time is set to a time within the range of the firing time period.

Furthermore, the firing time of the neuron 320 may be used as an index related to the neuron 320. For example, an evaluation function may be used that indicates a better evaluation as the difference between the firing time and the reference time becomes smaller.

Alternatively, the membrane potential at a reference time may be used as an index related to the neuron 320.

The learning portion 191 can learn the neural network 200 using the evaluation function described above, thereby learning to adjust the firing time of the neuron 320 in relation to the reference time.

This is expected to relatively increase (raise) the possibility of the neuron 320 firing.

Here, if the proportion of neurons 320 that do not fire among the neurons 320 included in the neural network 200 is high, the amount of information transmitted will be reduced, and the estimation accuracy by the neural network 200 will be reduced. In contrast, as described above, the likelihood of the neuron 320 firing becomes relatively high, and it is expected that the estimation accuracy of neural network 200 will improve.

In the following, an example will be described in which the learning portion 191 learns the neural network 200 by using the convolutional layer 231 and the fully connected layer 233 as the learning targets. Here, it is assumed that the input layer 220, the pooling layer 232, and the output layer 240 are excluded from the learning target. However, the pattern of the layer 210 that the learning portion 191 learns is not limited thereto. For example, some layers of the convolutional layer 231 may be excluded from learning. Furthermore, parameters of the output layer 240 may be included in the learning target.

In the following, an example will be described in which the learning portion 191 learns the neural network 200 using a loss function (cost function) as an evaluation function. The loss function here is a function in which the smaller the function value, the better the evaluation. However, the learning portion 191 may use, as the evaluation function, a function in which the larger the function value, the better the evaluation. In the following, an example will be described in which the neural network 200 performs class classification.

(when Using Firing Time as an Index)

When the firing time is used as an index related to the neuron 320, the learning portion 191 performs learning of the neural network 200 using, for example, the loss function C_{FT} shown in Equation (3).

$$\begin{matrix}[ Equation 3 ] & \\ {C}_{FT} = - {\sum }_{i = 1}^{{N}^{( L )}} {κ}_{i} ln {S}_{i} + {γ}_{1} T + {γ}_{2} {Q}_{FT} & ( 3 )\end{matrix}$$

Σᵢ₌₁^{N(L)}κᵢlnSᵢ is a term for improving the accuracy of the estimation by the neural network 200. The term for improving the accuracy of the estimation by the neural network 200 is also referred to as an estimation loss term.

L indicates the number of layers 210 that are the subject of learning among the layers 210 of the neural network 200.

N^{(L)} indicates the number of dimensions per channel in the L-th layer. Here, the L-th layer is a fully connected layer 233, and the number of channels in the L-th layer is one. It is also assumed that the L-th layer is used as the output layer 240, and the output of the neuron 320 in the L-th layer is used as the output of the neural network 200.

Therefore, let N^{(L)} denote the number of dimensions of the channels of neural network 200.

The L-th layer has neurons 320 whose number is equal to the number of classes. The neural network 200 then indicates the result of the class classification based on which of the neurons 320 in the L-th layer fires the earliest. The neurons in a layer are also called the neurons of that layer.

Here, i represents an identification number that identifies a class.

κᵢ represents the supervisor label. For example, when the neural network 200 performs class classification, κᵢ=1 may be set for the correct class, and κᵢ=0 may be set for the other classes.

In denotes the natural logarithm.

Sᵢ is the softmax function used for the i-th class and is expressed as in Equation (4).

$$\begin{matrix}[ Equation 4 ] & \\ {S}_{i} = \frac{exp ( \frac{- {t}_{i}^{( L )}}{{τ}_{soft}} )}{{\sum }_{j = 1}^{N ( L )} exp ( \frac{- {t}_{i}^{( L )}}{{τ}_{soft}} )} & ( 4 )\end{matrix}$$

exp represents the power of Napier's constant e.

Here, j, like i, represents an identification number that identifies a class.

t^{(L)}ⱼ indicates the firing time of the j-th spike signal that can be output from the L-th layer. t^{(L)}ⱼ is also referred to as the firing time of the j-th class spike signal.

τ_{soft} is a constant provided as a scale factor for adjusting the degree of change in the value of the softmax function Sᵢ when the firing time of the spike signal for each class changes, and τ_{soft}>0.

If the i-th class is correct, the spike signal of the i-th class fires earlier than the spike signals of the other classes, and the firing time t^{(L)}ᵢ of the spike signal of the i-th class takes a smaller value than the firing times of the spike signals of the other classes. Therefore, the sub-expression −τ^{(L)}ᵢ takes a larger value than in the other classes, and the value of the softmax function Sᵢ also takes a larger value than in the other classes.

However, the estimated loss term used by the learning portion 191 is not limited to a specific one. For example, the learning portion 191 may use a loss function in which a function other than a softmax function is used for the estimated loss term.

Both γ₁ and γ₂ are coefficients for adjusting the degree of influence of each term, where γ₁≥0 and γ₂≥0.

The sub-expression T is a sub-expression indicating the penalty for the output layer (here, the L-th layer), and is expressed as Equation (5).

$$\begin{matrix}[ Equation 5 ] & \\ T = {\sum }_{i = 1}^{{N}^{( L )}} {( {t}_{i}^{( L )} - {t}_{ref}^{( L )} )}^{2} & ( 5 )\end{matrix}$$

The closer the firing time t^{(L)}ᵢ of a spike signal that may be output from the L-th layer is to the reference time t^{(L)}_{ref} in the L-th layer, the smaller the value of the sub-expression T and the smaller the value of the loss function C_{FT}.

The sub-expression Q_{FT} is a sub-expression indicating a penalty for the hidden layer 230 to be learned other than the L-th layer (and therefore from the 1st layer to the L-lth layer), and is shown as in Equation (6).

$$\begin{matrix}[ Equation 6 ] & \\ {Q}_{FT} = {\sum }_{l = 1}^{L - 1} {Q}_{FT}^{( l )} & ( 6 )\end{matrix}$$

The sub-expression Q^{(l)}_{FT} is a sub-expression that indicates the penalty for the 1-th layer. Here, l takes an integer value in the range of 1≤l≤L−1.

When the l-th layer is a fully connected layer 233, the sub-expression Q^{(l)}_{FT} is expressed as Equation (7).

$$\begin{matrix}[ Equation 7 ] & \\ {Q}_{FT}^{( l )} = {\sum }_{i = 1}^{{N}^{( l )}} {( {t}_{i}^{( l )} - {t}_{ref}^{( l )} )}^{2} θ ( {t}_{i}^{( l )} - {t}_{ref}^{( l )} ) & ( 7 )\end{matrix}$$

N^{(l)} denotes the number of dimensions per channel in the l-th layer. As described above, the number of channels in the fully connected layer 233 is one, and in Equation (7), N^{(l)} indicates the number of neurons 320 in the l-th layer.

θ denotes a step function. If the argument of the step function θ is represented by x, then θ(x)=0 when x<0, and θ(x)=1 when x≥0.

In Equation (7), if the firing time t^{(l)}i of the i-th neuron 320 in the l-th layer is smaller (earlier) than the reference time t^{(l)}_{ref}, the penalty value for that neuron 320, (t^{(l)}ᵢ-t^{(l)}_{ref})²θ(t^{(l)}ᵢ-t^{(l)}_{ref}), becomes 0. Even when the firing time t^{(l)}ᵢ is equal to the reference time t^{(l)}_{ref}, the penalty value (t^{(l)}ᵢ-t^{(l)}_{ref})²θ(t^{(l)}ᵢ-t^{(l)}_{ref}) for neuron 320 becomes zero. On the other hand, if the firing time t^{(l)}ᵢ of the i-th neuron 320 in the l-th layer is greater (later) than the reference time t^{(l)}_{ref}, the penalty value for that neuron 320 is (t^{(l)}ᵢ-t^{(l)}_{ref})².

In this way, when the firing time t^{(l)}ᵢ of the neuron 320 is greater than the reference time t^{(l)}_{ref}, the penalty value for that neuron 320 becomes greater than 0, and the larger the value of the difference t^{(l)}ᵢ-t^{(l)}_{ref} obtained by subtracting the reference time t^{(l)}_{ref} from the firing time t^{(l)}ᵢ, the larger the penalty value becomes.

This is expected to make it difficult for the firing time of the l-th layer neuron 320 to become later than the reference time. Furthermore, when the firing time of the l-th layer neuron 320 becomes later than the reference time, the firing time is expected to become closer to the reference time. This is expected to make the l-th layer neurons 320 more likely to fire.

With respect to the convolutional layer 231, it has been found that simply adding up the penalty values for all neurons 320 using Equation (7) results in the effect of the penalty becoming too large due to the nature of weight sharing.

Therefore, when the l-th layer is a convolutional layer 231, the sub-expression Q^{(l)}_{FT} shown in Equation (8) is used.

$$\begin{matrix}[ Equation 8 ] & \\ {Q}_{FT}^{( l )} = \frac{1}{{N}^{( l )}} {\sum }_{c = 1}^{{C}^{( l )}} {\sum }_{i = 1}^{{N}^{( l )}} {( {t}_{c , i}^{( l )} - {t}_{ref}^{( l )} )}^{2} θ ( {t}_{c , i}^{( l )} - {t}_{ref}^{( l )} ) & ( 8 )\end{matrix}$$

C^{(l)} denotes the number of channels in the l-th layer.

c denotes an identification number for identifying a channel in the l-th layer, and takes an integer value such that 1≤c≤C^{(l)}.

In Equation (8), the sub-expression of the penalty for each neuron 320, (t^{(l)}_{c, i}-t^{(l)}_{ref})²θ(t^{(l)}_{c, i}-t^{(l)}_{ref}), is obtained by replacing the notation t^{(l)}ᵢ of the firing time from the sub-expression of the penalty for each neuron 320 in Equation (7), (t^{(l)}ᵢ-t^{(l)}_{ref})²θ(t^{(l)}ᵢ-t^{(l)}_{ref}), with the notation t^{(l)}_{c,i} which explicitly indicates the channel identification number c. Thus, the penalty sub-expression for each neuron 320 in Equation (8) is the same as in Equation (7).

Also, in Equation (8), the penalty values for all neurons 320 in the l-th layer are summed up, similarly to Equation (7).

On the other hand, Equation (8) differs from Equation (7) in that the sum of the penalty values for all neurons 320 in the l-th layer is divided by the number of dimensions per channel, N^{(l)}. N^{(l)} can also be considered as the number of neurons 320 per channel in the l-th layer.

This difference is to address the above-mentioned problem of the effect of penalties on the convolutional layer 231 becoming too large.

In this way, it is expected that by adjusting the magnitude of the penalty value for the convolutional layer 231, it will be easier to obtain the effect of penalties due to other sub-expressions included in the loss function C_{FT}. Specifically, it is expected that it will be easier to obtain not only the effect of the penalty on the convolutional layer 231, but also the effect of the penalty on the fully connected layer 233 and the effect of the estimated loss term.

By making it easier to obtain the effect of the penalty on the convolutional layer 231, it is expected that the possibility of the neuron 320 in the convolutional layer 231 firing will become relatively high due to the influence of the evaluation criterion that the firing time of the neuron in the convolutional layer 231 be before the reference time (earlier than the reference time).

By making it easier to obtain the effect of the penalty on the fully connected layer 233, it is expected that the possibility of the neuron 320 in the fully connected layer 233 firing will become relatively high due to the influence of the evaluation criterion that the firing time of a neuron in the fully connected layer 233 is before a reference time.

Since the likelihood of neurons 320 in the convolutional layer 231 firing and the likelihood of neurons 320 in the fully connected layer 233 firing are relatively high, it is expected that information will be more easily transmitted between layers 210, enabling the neural network 200 to perform estimations with relatively high accuracy.

In addition, since it becomes easier to obtain the effect of the estimated loss term, it is expected that the neural network 200 will be able to perform estimation with a relatively high degree of accuracy.

The reference time t^{(l)}_{ref} is, for example, as shown in Equation (9).

$$\begin{matrix}[ Equation 9 ] & \\ {t}_{ref}^{( l )} = \frac{( L - l ) \cdot {t}_{first} + ( l - 1 ) \cdot {t}_{end}}{L - 1} & ( 9 )\end{matrix}$$

Here, the number of layers 210 being learned is shown.

Here, l indicates an identification number for identifying the layer 210 that is the target of learning. l takes an integer value of 1≤l≤L.

t_{first} indicates a reference time set in the first layer 210 among the layers 210 being the target of learning (i.e., the first layer among the layers 210 being the target of learning).

t_{end} indicates a reference time set for the last layer 210 among the layers 210 being the target of learning (i.e., the L-th layer among the layers 210 being the target of learning).

t_{first} and t_{end} are set in advance (before neural network 200 starts executing the process) based on the characteristics of the hardware when the neural network 200 is implemented in hardware, for example.

According to Equation (9), the time obtained by equally dividing the time period from t_{first} to t_{end} is calculated as the reference time in the layer 210 being learned. For example, when L=8, the reference time in each layer 210 is as follows:

$${t}_{ref}^{( 1 )} = ( 7 \cdot {t}_{first} + 0 \cdot {t}_{end} ) / 7 = {t}_{first}$$

$${t}_{ref}^{( 2 )} ( 6 \cdot {t}_{first} + 1 \cdot {t}_{end} ) / 7$$

$${t}_{ref}^{( 3 )} = ( 5 \cdot {t}_{first} + 2 \cdot {t}_{end} ) / 7$$

$$…$$

$${t}_{ref}^{( 8 )} = ( 0 \cdot {t}_{first} + 7 \cdot {t}_{end} ) / 7 = {t}_{end}$$

In this way, by allocating the reference times at equal time intervals, it is possible to accommodate the case where spike signals are transmitted at approximately the same time between each layer 210 that is the subject of learning. As a result, when spike signals are transmitted between each layer 210 being learned at approximately the same time, the likelihood of a spike firing becomes relatively high, and it is expected that the neural network 200 will be able to make estimations with relatively high accuracy.

For example, consider a case in which the firing time period of each layer 210 being the subject of learning is set to a time period obtained by dividing the time period determined as the firing time period for all of these layers into equal time widths. In this case, by setting the reference time of each layer 210 based on Equation (9), it is possible to set the reference time within the range of the firing time period of each layer 210.

In addition, if there is a neuron 320 that is not firing and the learning portion 191 cannot calculate the value of the evaluation function C_{FT}, the learning portion 191 may calculate the value of the evaluation function C_{FT} by setting the firing time of the non-firing neuron 320 as a sufficiently late time. For example, if there is a neuron 320 that is not firing within the firing time period, the learning portion 191 may calculate the value of the evaluation function C_{FT} by setting the firing time of that neuron 320 to the end time of the firing time period or a time later than that.

This allows the learning portion 191 to calculate the value of the evaluation function C_{FT} and learn the neural network 200 even if there is a neuron 320 that is not firing.

### (When Membrane Potential is Used as an Index)

When the membrane potential at the reference time is used as an index for the neuron 320, the learning portion 191 performs learning of the neural network 200 using, for example, the loss function C_{MP} shown in Equation (10).

$$\begin{matrix}[ Equation 10 ] & \\ {C}_{MP} = - {\sum }_{i = 1}^{{N}^{( L )}} {κ}_{i} ln {S}_{i} + {γ}_{2} {Q}_{MP} & ( 10 )\end{matrix}$$

The loss estimation term Σᵢ₌₁^{N(L)}κᵢlnSᵢ is the same as in Equation (3).

Similarly to the case of Equation (3), γ₂ is a coefficient for adjusting the degree of influence of each term, and γ₂≥0.

The sub-expression Q_{MP} is a sub-expression that indicates the penalty for the hidden layer 230 (and therefore the 1st layer to the L-lth layer) that is the target of learning other than the L-th layer, and is expressed as Equation (11).

Experimental results have shown that the estimation accuracy of the neural network 200 is higher when a sub-expression indicating a penalty is not provided for the L-th layer. Therefore, Equation (11) shows an example of a loss function in the case where a sub-expression indicating a penalty is not provided for the L-th layer.

$$\begin{matrix}[ Equation 11 ] & \\ {Q}_{MP} = {\sum }_{l = 1}^{L - 1} {Q}_{MP}^{( l )} & ( 11 )\end{matrix}$$

The sub-expression Q^{(l)}_{MP} is a sub-expression that indicates the penalty for the 1-th layer. Here, l takes an integer value in the range of 1≤l≤L−1.

When the l-th layer is a fully connected layer 233, the sub-expression Q^{(l)}_{MP} is expressed as Equation (12).

$$\begin{matrix}[ Equation 12 ] & \\ {Q}_{MP}^{( l )} = {( 1 - \frac{1}{{N}^{( l )} \cdot B} {\sum }_{b = 1}^{B} {\sum }_{i = 1}^{{N}^{( l )}} {v}_{b , i}^{( l )} ( {t}_{ref}^{( l )} ) )}^{2} & ( 12 )\end{matrix}$$

B indicates a batch size. b indicates an identification number for identifying a batch. b takes an integer value in the range of 1≤b≤B.

In an experiment using the membrane potential at a reference time as the index, it was found that mini-batch learning resulted in higher accuracy of estimation by the neural network 200 than online learning. Therefore, Equation (12) shows an example of a sub-expression when performing mini-batch learning.

v^{(l)}_{b,i}(t^{(l)}_{ref}) denotes the membrane potential of the i-th neuron 320 in the l-th layer at the reference time t^{(l)}_{ref} for the b-th data in the mini-batch.

In addition, in Equation (12), the membrane potential threshold (firing threshold) at which the neuron 320 fires is set to 1.

In accordance with mini-batch learning, in Equation (12), the membrane potential v^{(l)}_{b,i}(t^{(l)}_{ref}) is averaged for all neurons 320 in the l-th layer and for all mini-batches, and the squared error with a threshold is calculated. In this way, by adopting a combination of mini-batch learning and averaging the membrane potential, the accuracy of estimation by the neural network 200 was found to be relatively high. Therefore, Equation (12) shows an example of a sub-expression when mini-batch learning is performed and the membrane potential is averaged.

In the calculation of Equation (12), it is assumed that the membrane potential is not reset even when the neuron 320 fires.

In Equation (12), the closer the average value of the membrane potential v^{(l)}_{b,i}(t^{(l)}_{ref}) at the reference time is to the threshold value, the smaller the penalty value becomes.

This is expected to make it easier for the firing time of the layer 1 neuron 320 to approach the reference time. This is expected to make the l-th layer neurons 320 more likely to fire.

For the convolutional layer 231, the average value of the penalty value per channel may be calculated. For example, when the l-th layer is the convolutional layer 231, the learning portion 191 may use the sub-expression Q^{(l)}_{MP} shown in Equation (13).

$$\begin{matrix}[ Equation 13 ] & \\ {Q}_{MP}^{( l )} = \frac{1}{{C}^{( l )}} {\sum }_{C = 1}^{{C}^{( l )}} {( 1 - \frac{1}{{N}^{( 1 )} \cdot B} {\sum }_{b = 1}^{B} {\sum }_{i = 1}^{{N}^{( l )}} {v}_{b , c , i}^{( l )} ( {t}_{ref}^{( l )} ) )}^{2} & ( 13 )\end{matrix}$$

v^{(l)}_{b,i}(t^{(l)}_{ref}) denotes the membrane potential of the i-th neuron 320 of the c-th channel in the l-th layer at the reference time t^{(l)}_{ref} in the b-th batch. In Equation (13), the sub-expression for the penalty for one channel is (1−1/(N⁽¹⁾·B)Σ_{b=1}^{B}Σⁱ⁼¹N^{(l)}v^{(l)}_{b,c,i}(t^{(l)}_{ref}))². This sub-expression is obtained by replacing the notation v^{(l)}_{b,i}(t^{(l)}_{ref}) of the membrane potential at the reference time from the sub-expression for the penalty for one channel in Equation (12), (1−1/(N^{(l)}·B)Σ_{b=1}^{B}Σⁱ⁼¹N^{(l)}v^{(l)}_{b,i}(t^{(l)}_{ref}))², with the notation v^{(l)}_{b,c,i}(t^{(l)}_{ref}), which explicitly indicates the channel identification number c. Thus, the sub-expression for the penalty for one channel in Equation (13) is the same as in Equation (12).

On the other hand, Equation (13) differs from Equation (12) in that the penalty value for one channel is summed up for all channels in the l-th layer. Furthermore, Equation (13) differs from Equation (12) in that the value obtained by summing up the penalty value for one channel for all channels in the l-th layer is divided by the number of dimensions per channel, N^{(l)}.

The penalty value for one channel is summed up for all channels in the l-th layer and divided by the number of dimensions per channel, N^{(l)} to address the problem of the effect of the penalty on the convolutional layer 231 becoming too large, as mentioned above.

In this way, it is expected that by adjusting the magnitude of the penalty value for the convolutional layer 231, it will be easier to obtain the effect of penalties due to other sub-expressions included in the loss function C_{MP}. Specifically, it is expected that it will be easier to obtain not only the effect of the penalty on the convolutional layer 231, but also the effect of the penalty on the fully connected layer 233 and the effect of the estimated loss term.

By making it easier to obtain the effect of the penalty on the convolutional layer 231, it is expected that the average firing time of the neurons in the convolutional layer 231 will approach the reference time more easily, and the possibility of the neurons 320 in the convolutional layer 231 firing will become relatively higher.

By making it easier to obtain the effect of the penalty on the fully connected layer 233, it is expected that the average firing time of neurons in the fully connected layer 233 will approach the reference time more easily, and that the possibility of neurons 320 in the fully connected layer 233 firing will become relatively high.

Since the likelihood of neurons 320 in the convolutional layer 231 firing and the likelihood of neurons 320 in the fully connected layer 233 firing are relatively high, it is expected that information will be more easily transmitted between layers 210, enabling the neural network 200 to perform estimations with relatively high accuracy.

In addition, since it becomes easier to obtain the effect of the estimated loss term, it is expected that the neural network 200 will be able to perform estimation with a relatively high degree of accuracy.

### About the Experiment

A learning experiment was carried out using the learning system 1 in both cases where the firing time was used as an index and where the membrane potential at the reference time was used.

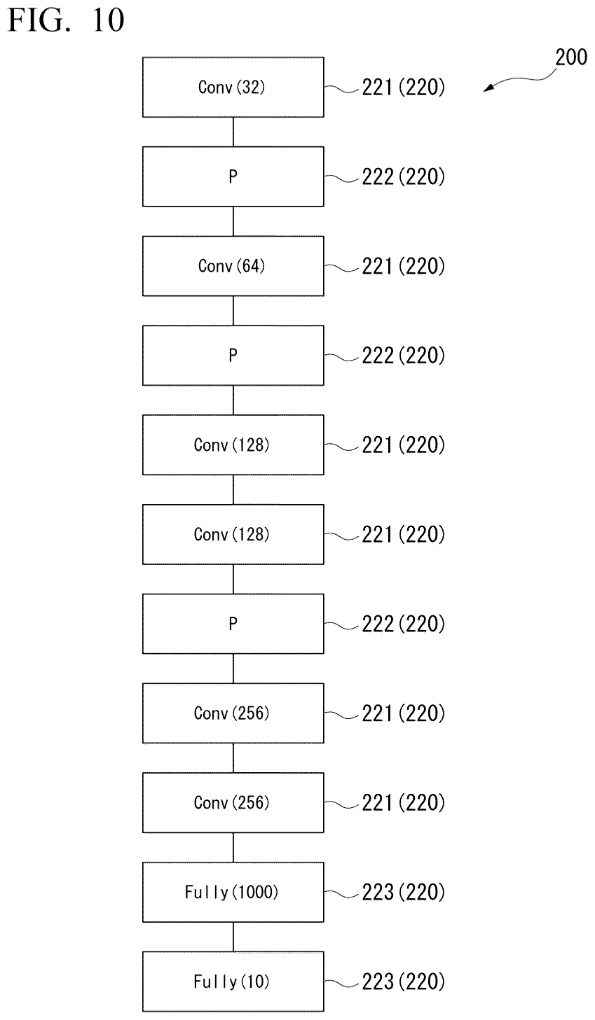

FIG. 10 is a diagram showing a first example of the configuration of a neural network 200 used in the experiment. FIG. 10 shows the hidden layer 230 of the neural network 200 used in an experiment in which the firing time is used as the index.

In FIG. 10, the convolutional layer 231 is indicated by “Conv”, the pooling layer 232 is indicated by “P”, and the fully connected layer 233 is indicated by “Fully”. The number in parentheses after “Conv” indicates the number of channels in that layer. The number in parentheses after “Fully” indicates the number of neurons 320 in that layer.

In the configuration shown in FIG. 10, the neural network 200 includes, in this order, a 32-channel convolutional layer 231, a pooling layer 232, a 64-channel convolutional layer 231, a pooling layer 232, a 128-channel convolutional layer 231, a 128-channel convolutional layer 231, a pooling layer 232, a 256-channel convolutional layer 231, a 256-channel convolutional layer 231, a fully connected layer 233 of 1000 neurons, and a fully connected layer 233 of 10 neurons.

The kernel size of the convolutional layer 231 was 3×3, the stride was 1, and the padding was 1. The kernel size of the pooling layer 232 was 2×2, the stride was 2, and the padding was 0. Moreover, the pooling layer 232 performs the above-mentioned max pooling by outputting the spike signal that first reaches the window.

In addition, the convolutional layer 231 and the fully connected layer 233 were used as the learning targets, and the loss function C_{FT} shown in Equation (3) was used.

The learning rate was set to 7×10⁻⁴, γ₁=0.8 in Equation (3), τ_{soft}=0.07 in Equation (4), and t_{first}=2 and t_{end}=3 in Equation (9). Learning was performed for 300 epochs for each of the cases where γ₂=0 and γ₂=1.9×10⁻³ in Equation (3). Using CIFAR-10 as training data, classification into 10 classes was performed.

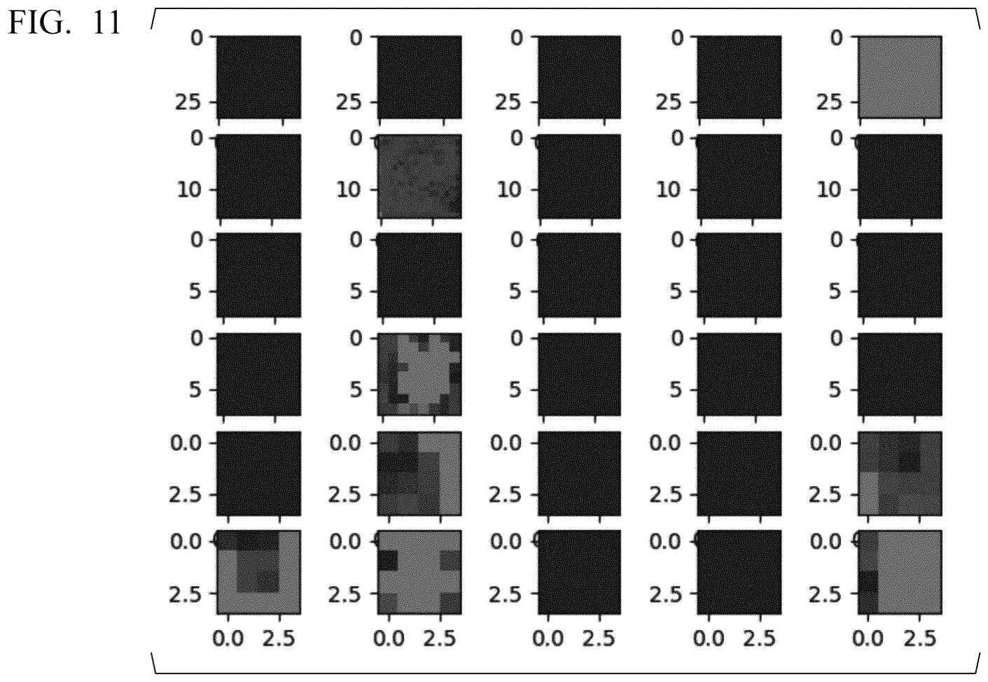

FIG. 11 is a diagram showing a first example of the firing state of a neuron 320 in the neural network 200. FIG. 11 shows a graph of the firing state of the neuron 320 in the convolutional layer 231 when γ₂=0, using the firing time as an index.

Here, setting γ₂=0 can be understood as not performing learning to make neurons 320 in the hidden layer 230 more likely to fire using the γ₂Q_{FT} term in Equation (3).

FIG. 11 shows a graph of the firing states of the neurons 320 for each layer and each channel of the neural network 200. One row corresponds to one convolutional layer 231, and one column corresponds to one channel.

The horizontal axis of the layer-by-channel graph corresponds to time, and the vertical axis corresponds to the neuron 320 identification number.

The brighter (whiter) the graph, the greater the proportion of epochs in which the neuron 320 fired out of the 300 epochs. The darker (blacker) the graph, the smaller the percentage of epochs in which neuron 320 fired out of the 300 epochs. A solid black graph indicates that no neurons 320 are firing in that channel at that layer.

Furthermore, when the firing time was used as the index and γ₂=0 was set, the test data recognition rate by the neural network 200 was 70.86%.

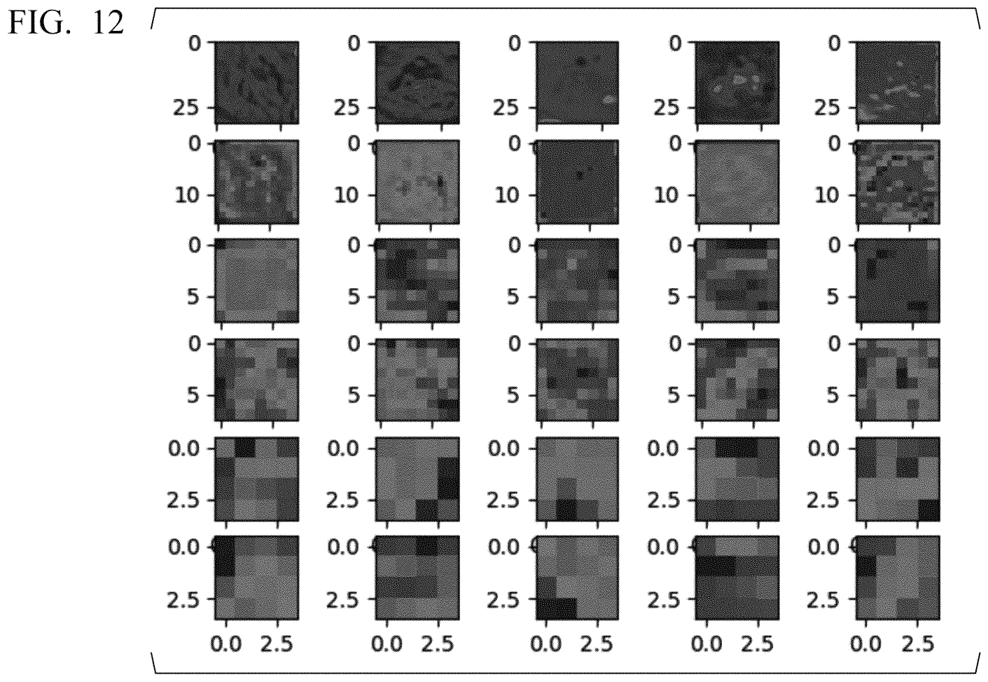

FIG. 12 is a diagram showing a second example of the firing state of the neurons 320 in the neural network 200. FIG. 12 shows a graph of the firing state of the neurons 320 in the convolutional layer 231 when γ₂=1.9×10⁻³ is used as an index using the firing time. As in FIG. 11, FIG. 12 also shows a graph of the firing states of the neurons 320 for each layer and each channel of the neural network 200. One row corresponds to one convolutional layer 231, and one column corresponds to one channel.

The horizontal axis of the layer-by-channel graph corresponds to time, and the vertical axis corresponds to the neuron 320 identification number.

The brighter (whiter) the graph, the greater the proportion of epochs in which the neuron 320 fired out of the 300 epochs. The darker (blacker) the graph, the smaller the percentage of epochs in which neuron 320 fired out of the 300 epochs.

Furthermore, when the firing time was used as the index and γ₂=1.9×10⁻³ was set, the test data recognition rate by the neural network 200 was 83.74%.

Comparing FIG. 11 with FIG. 12, the graph in FIG. 12 is brighter, which can be interpreted as indicating that the possibility of neuron 320 firing is higher. In the case of FIG. 12, the probability that the neuron 320 will fire is higher than in the case of FIG. 11, making it easier for information to be transmitted to the next layer, which can be considered to result in an improvement in the test data recognition rate.

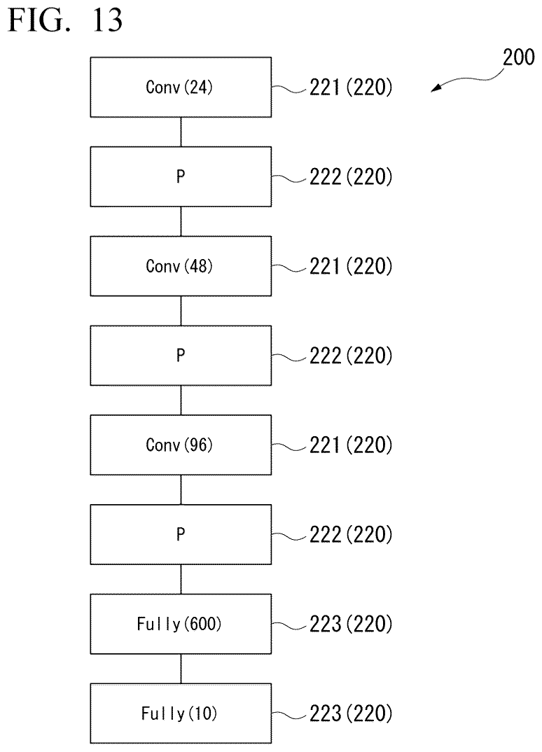

FIG. 13 is a diagram showing a second example of the configuration of the neural network 200 used in the experiment. FIG. 13 shows the hidden layer 230 of the neural network 200 used in an experiment in which the membrane potential at the reference time is used as the index.

As in FIG. 10, in FIG. 13, the convolutional layer 231 is denoted by “Conv”, the pooling layer 232 is denoted by “P”, and the fully connected layer 233 is denoted by “Fully”. The number in parentheses after “Conv” indicates the number of channels in that layer. The number in parentheses after “Fully” indicates the number of neurons 320 in that layer.

In the configuration shown in FIG. 13, the neural network 200 includes, in that order, a 24-channel convolutional layer 231, a pooling layer 232, a 48-channel convolutional layer 231, a pooling layer 232, a 96-channel convolutional layer 231, a fully connected layer 233 of 600 neurons, and a fully connected layer 233 of 10 neurons.

The kernel size of the convolutional layer 231 was 3×3, the stride was 1, and the padding was 1. The kernel size of the pooling layer 232 was 2×2, the stride was 2, and the padding was 0. Moreover, the pooling layer 232 performs the above-mentioned max pooling by outputting the spike signal that first reaches the window.

In addition, the convolutional layer 231 and the fully connected layer 233 served as the learning targets, and the loss function C_{MP} shown in Equation (10) was used.

The learning rate was set to 1×10⁻⁴, τ_{soft}=1 in Equation (4), t_{first}=17, and t_{end}=25 in Equation (9). Learning was performed for 300 epochs for each of the cases where γ₂=0 and γ₂=1.0 in Equation (10).

Using CIFAR-10 as training data, classification into 10 classes was performed.

FIG. 14 is a diagram showing a third example of the firing state of the neurons 320 in the neural network 200. FIG. 14 is a graph showing the firing state of the neuron 320 in the convolutional layer 231 when γ₂=0, using the membrane potential at the reference time as an index. Here, setting γ₂=0 can be understood as not performing learning to make neurons 320 in hidden layer 230 more likely to fire using the γ₂Q_{FT} term in Equation (10).

FIG. 14 shows a graph of the firing states of the neurons 320 for each layer and each channel of the neural network 200. One row corresponds to one convolutional layer 231, and one column corresponds to one channel.

The horizontal axis of the layer-by-channel graph corresponds to time, and the vertical axis corresponds to the neuron 320 identification number.

The brighter (whiter) the graph, the greater the proportion of epochs in which the neuron 320 fired out of the 300 epochs. The darker (blacker) the graph, the smaller the percentage of epochs in which neuron 320 fired out of the 300 epochs. A solid black graph indicates that no neurons 320 are firing in that channel at that layer.

Furthermore, when the membrane potential at the reference time was used as the index and γ₂=0 was set, the test data recognition rate by the neural network 200 was 70.10%.

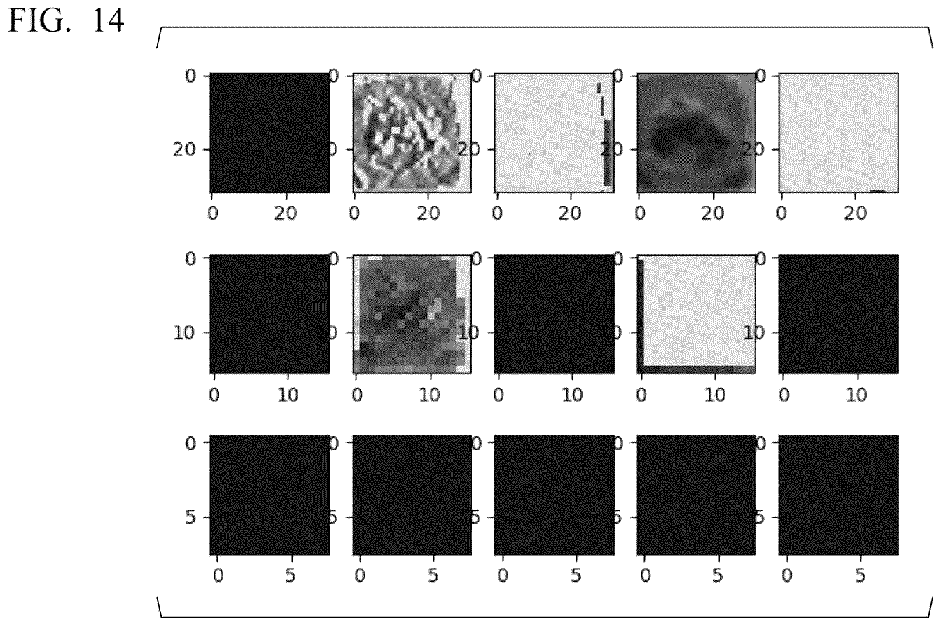

FIG. 15 is a diagram showing a fourth example of the firing state of the neurons 320 in the neural network 200. FIG. 15 is a graph showing the firing state of the neuron 320 in the convolutional layer 231 when γ₂=1.0, using the membrane potential at the reference time as an index.

As in FIG. 14, FIG. 15 also shows a graph of the firing states of the neurons 320 for each layer and each channel of the neural network 200. One row corresponds to one convolutional layer 231, and one column corresponds to one channel.

The horizontal axis of the layer-by-channel graph corresponds to time, and the vertical axis corresponds to the neuron 320 identification number.

The brighter (whiter) the graph, the greater the proportion of epochs in which the neuron 320 fired out of the 300 epochs. The darker (blacker) the graph, the smaller the percentage of epochs in which neuron 320 fired out of the 300 epochs.

Furthermore, when the membrane potential at the reference time was used as the index and γ₂=1.0 was set, the test data recognition rate by the neural network 200 was 84.18%.

Comparing FIG. 14 with FIG. 15, the graph in FIG. 15 is brighter, which can be interpreted as indicating that the possibility of the neuron 320 firing is higher. In the case of FIG. 15, the neurons 320 are more likely to fire than in the case of FIG. 14, making it easier for information to be transmitted to the next layer, which can be considered to result in an improvement in the test data recognition rate.

As described above, the learning portion 191 performs learning of the neural network 200 using an evaluation function including a predetermined reference time given to each layer 210 of the neural network 200 and an index related to the neurons 320. The neural network 200 is a spiking neural network using time-to-first-spike coding.

According to the learning device 100, learning of the neural network 200 can be performed so as to adjust the firing time of the neuron 320 in relation to the reference time, and it is expected that the possibility of the neuron 320 firing will become relatively high. The relatively high probability of the neurons 320 firing makes it easier for information to be transmitted to the next layer, and is expected to improve the accuracy of estimation by neural network 200.

Moreover, the index relating to the neuron 320 is the firing time of the neuron 320.

According to the learning device 100, since an index based on the firing time used by the neural network 200 to make an estimation and a reference time which is a predetermined time is used, there is no need to separately prepare an index for performing learning of the neural network 200. In this respect, according to the learning device 100, the burden of performing learning of the neural network 200 is relatively small. Furthermore, the learning device 100 is expected to be able to adjust the firing times with a relatively high degree of accuracy by using an index that uses the firing times, which are the subject of adjustment in learning.

Furthermore, the learning portion 191 performs learning of the neural network 200 using an evaluation function including a sub-expression that gives a better evaluation when the firing time is earlier than the reference time than when the firing time is later than the reference time.

According to the learning device 100, learning can be performed so that the firing time tends to be earlier than the reference time. In this respect, the learning device 100 is expected to increase the likelihood that the neuron 320 will fire, thereby improving the accuracy of estimation by the neural network 200.

Furthermore, one or more hidden layers 230 are convolutional layers 231. The convolutional layer 231 is a convolutional layer that uses spiking neurons. The learning portion 191 performs learning of the neural network 200 using an evaluation function that includes a sub-expression that sums up, for all neurons in that layer, sub-expressions that give a better evaluation when the firing time is earlier than the reference time than when the firing time is later than the reference time, and then divides the sum by the number of neurons per channel in that layer. The sub-expression Q^{(l)}_{FT} shown in Equation (8) corresponds to an example of a sub-expression sums up, for all neurons in that layer, sub-expressions that give a better evaluation when the firing time is earlier than the reference time than when the firing time is later than the reference time, and then divides the sum by the number of neurons per channel in that layer.

The learning device 100 can address the finding that simply adding up the penalty values for all neurons 320 would result in the effect of the penalty becoming too large due to the nature of weight sharing, and so it is expected that the accuracy of estimation by the neural network 200 will be relatively high.

In addition, the learning portion 191 learns the spiking neural network using an evaluation function that includes a sub-expression that indicates a better evaluation when the firing time is earlier than the reference time than when the firing time is later than the reference time, and that indicates a better evaluation as the firing time is closer to the reference time when the firing time is later than the reference time.

According to the learning device 100, even if the firing time becomes later than the reference time, the firing time approaches the reference time, which is expected to increase the possibility that the neuron 320 will fire. As a result, it is expected that the accuracy of estimation by the neural network 200 in the learning device 100 will improve.

Moreover, the index relating to the neuron 320 is the membrane potential of the neurons 320 at the reference time.

According to the learning device 100, the membrane potential used for firing the neuron 320 is used as an index, and therefore there is no need to prepare a separate index. In this respect, according to the learning device 100, the burden of performing learning of the neural network 200 is relatively small. Furthermore, since the learning device 100 uses indices other than the firing time, it is expected that even if there are neurons 320 that do not fire, the value of the evaluation function can be calculated and the neural network 200 can be learned.

Furthermore, the learning portion 191 performs learning of the neural network 200 by mini-batch learning.

According to the learning device 100, it is possible to learn the neural network 200 in accordance with experimental results that show that mini-batch learning improves the accuracy of estimation by the neural network 200. In this respect, the learning device 100 is expected to provide a relatively high level of accuracy in estimation by the neural network 200.

In addition, a firing time period is set for each layer 210 of the neural network 200. The firing time period is the time period during which the firing time of a neuron 320 is transmitted to the next layer 210. The reference time is set for each layer 210 of the neural network 200 to a time within the firing time period of that layer 210. The learning portion 191 learns the neural network 200 by regarding the firing time of a neuron that has not fired within its firing time period as the end time of that firing time period or a time that is later than that, which is determined in advance.

This allows the learning portion 191 to calculate the value of the evaluation function and learn the neural network 200 even if there is a neuron 320 that is not firing.

Furthermore, for layers 210 that are the subject of learning of layers of the neural network 200, a reference time is set for each layer 210, the reference time being obtained by equally dividing the time from the reference time determined for the first layer 210 in the order of transmission of spike signals of layers that are the subject of learning to the reference time determined for the last layer 210 in that order.

According to the learning device 100, the reference times are allocated at equal time intervals, so that it is possible to handle the case where spike signals are transmitted at approximately the same time between each layer 210 that are the subject of learning. In particular, according to the learning device 100, when spike signals are transmitted between each layer 210 that are the subject of learning at approximately the same time, the likelihood of a spike firing becomes relatively high, and it is expected that the neural network 200 will be able to perform estimation with relatively high accuracy.

Furthermore, one or more hidden layers 230 are pooling layers 232 that output spike signals depending on the timing at which any one of the spike signals included in the window to be pooled first arrives at the hidden layer. The learning portion 191 performs learning on the neural network 200, excluding the pooling layer 232 of the hidden layer 230 from the learning target.

According to the learning device 100, the pooling layer 232 can output a spike signal without the need to calculate the firing time, such as by calculating the firing time using a membrane potential. This allows the pooling layer 232 to output data relatively quickly. In particular, for the pooling layer 232, there is no need to provide an ignition time period. In this regard, it is expected that the neural network 200 will be able to perform inferences in a relatively short time.

### Second Embodiment

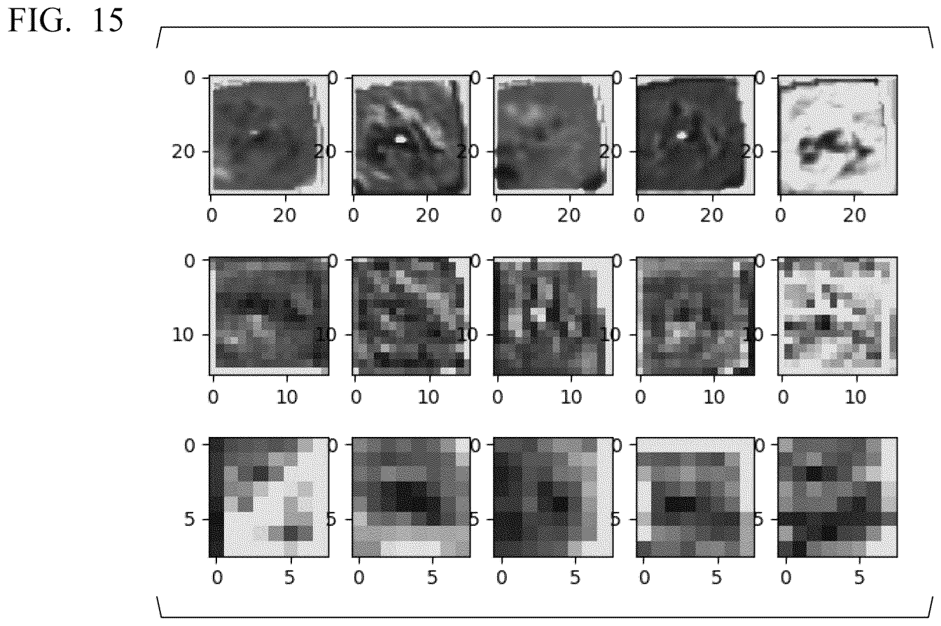

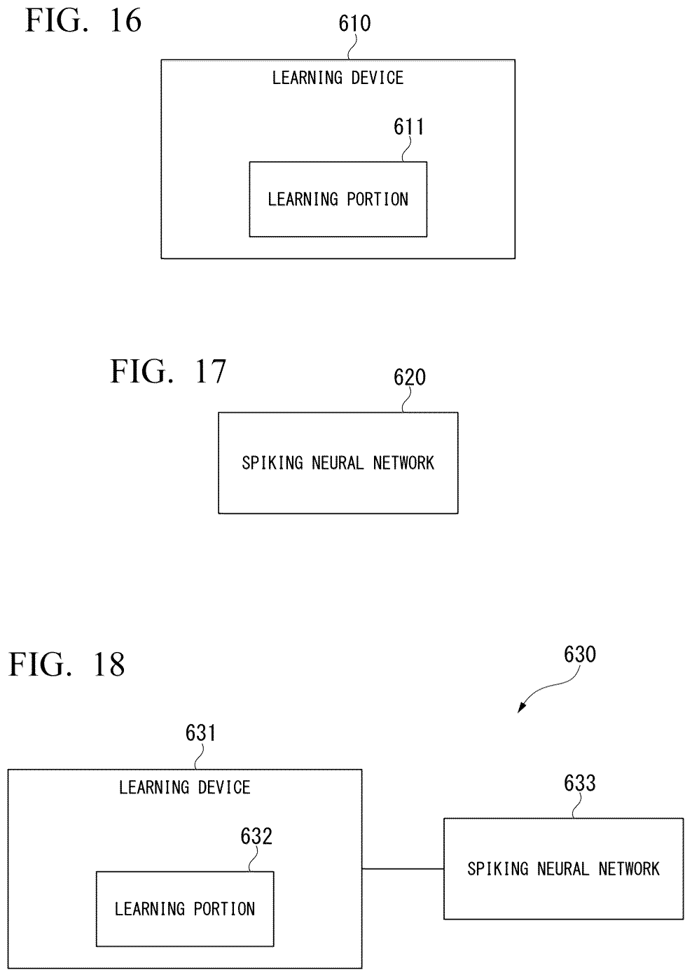

FIG. 16 is a diagram illustrating an example of a configuration of a learning device according to at least one embodiment. A learning device 610 in the configuration shown in FIG. 16 is provided with a learning portion 611.

With this configuration, the learning portion 611 performs learning of the spiking neural network using time-to-first-spike coding, by using an evaluation function including a predetermined reference time given to each layer of the spiking neural network and an index related to neurons.

The learning portion 611 corresponds to an example of a learning means.

According to the learning device 610, learning of the neural network can be performed so as to adjust the firing time of the neuron in relation to the reference time, and it is expected that the possibility of the neuron firing will become relatively high. The relatively high probability of the neurons firing makes it easier for information to be transmitted to the next layer, and is expected to improve the accuracy of estimation by the spiking neural network.

### Third Embodiment

FIG. 17 is a diagram illustrating an example of a spiking neural network according to at least one embodiment.

A spiking neural network 620 shown in FIG. 17 is a spiking neural network that uses time-to-first-spike coding and has been learned using an evaluation function that includes a predetermined reference time given to each layer of the spiking neural network using time-to-first-spike coding and an index related to neurons.

The spiking neural network 620 has been learned to adjust the firing time of neurons relative to a reference time, and is expected to make the neurons more likely to fire. Since the probability of a neuron firing is relatively high, information is more easily transmitted to the next layer, and it is expected that the accuracy of estimations by the spiking neural network 620 will be relatively high.

### Fourth Embodiment

FIG. 18 is a diagram illustrating an example of a configuration of a learning system according to at least one embodiment. In the configuration shown in FIG. 18, a learning system 630 is provided with a learning device 631 and a spiking neural network 633. The learning device 631 is provided with a learning portion 632.

In this configuration, the spiking neural network 633 is a spiking neural network using time-to-first-spike coding. The learning portion 632 performs learning of the spiking neural network 633 using an evaluation function including a predetermined reference time given to each layer of the spiking neural network 633 and an index related to neurons.

The learning portion 632 corresponds to an example of a learning means.

According to the learning system 630, learning of the neural network can be performed so as to adjust the firing time of the neuron in relation to the reference time, and it is expected that the possibility of the neuron firing will become relatively high. The relatively high probability of the neurons firing makes it easier for information to be transmitted to the next layer, and is expected to improve the accuracy of estimation by the spiking neural network 633.

### Fifth Embodiment

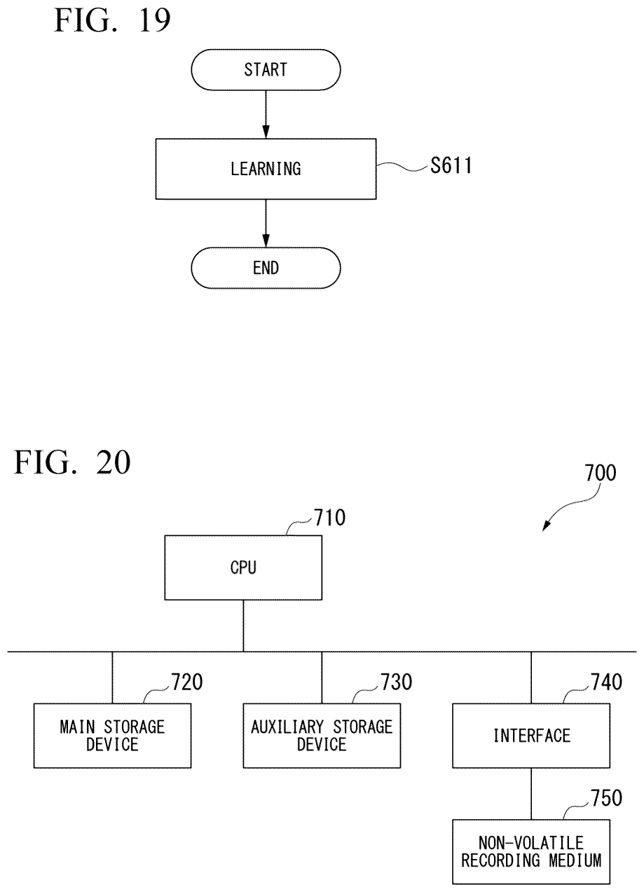

FIG. 19 is a diagram illustrating an example of a processing procedure in a learning method according to at least one embodiment. The learning method shown in FIG. 19 includes performing learning (Step S611).

In performing learning (Step S611), the computer performs learning of the spiking neural network using time-to-first-spike coding, by using an evaluation function including a predetermined reference time given to each layer of the spiking neural network and an index related to neurons.

According to the learning method shown in FIG. 19, learning of the neural network can be performed so as to adjust the firing time of the neuron in relation to the reference time, and so it is expected that the possibility of the neuron firing will become relatively high. The relatively high probability of the neurons firing makes it easier for information to be transmitted to the next layer, and is expected to improve the accuracy of estimation by the spiking neural network.

FIG. 20 is a diagram illustrating a computer configuration in accordance with at least one embodiment.

In the configuration shown in FIG. 20, a computer 700 is provided with a CPU 710, a main storage device 720, an auxiliary storage device 730, an interface 740, and a non-volatile recording medium 750.

Any one or more of the above-mentioned learning device 100, neural network 200, learning device 610, spiking neural network 620, learning device 631, and spiking neural network 633, or a part thereof, may be implemented in the computer 700. In this case, the operations of the above-mentioned processing units are stored in the auxiliary storage device 730 in the form of a program. The CPU 710 reads the program from the auxiliary storage device 730, loads it into the main storage device 720, and executes the above-mentioned processing in accordance with the program. Furthermore, the CPU 710 allocates storage areas in the main storage device 720 corresponding to the above-mentioned respective storage units in accordance with the program. Communication between each device and other devices is performed by the interface 740 including a communication function and performing communication under the control of the CPU 710. The interface 740 also has a port for a non-volatile recording medium 750, and thereby reads information from the non-volatile recording medium 750 and writes information to the non-volatile recording medium 750.

When the learning device 100 is implemented in the computer 700, the operations of the processing portion 190 and each unit thereof are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area for the storage portion 180 in the main storage device 720 in accordance with the program. Communication with other devices by the communication portion 110 is performed by the interface 740 including a communication function and operating under the control of the CPU 710. The display of images by the display portion 120 is executed by including the interface 740 equipped with a display device and displaying various images under the control of the CPU 710. The operation input portion 130 receives user operations by including the interface 740 equipped with an input device and receiving the user operations under the control of the CPU 710.

When the neural network 200 is implemented in the computer 700, the operation of each part thereof is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the neural network 200 to perform processing in accordance with the program. Communication between neural network 200 and other devices is performed by the interface 740, which has a communication function and operates under the control of CPU 710. Interaction between the neural network 200 and a user is carried out by the interface 740 including an input device and an output device, presenting information to the user via the output device under the control of the CPU 710, and accepting user operations via the input device.

When the learning device 610 is implemented in the computer 700, the operation of the learning portion 611 is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the learning device 610 to perform processing in accordance with the program. Communication with other devices by the learning device 610 is performed by the interface 740 including a communication function and operating under the control of the CPU 710. Interaction between the learning device 610 and a user is carried out by the interface 740 including an input device and an output device, presenting information to the user via the output device under the control of the CPU 710, and accepting user operations via the input device.

When the spiking neural network 620 is implemented in the computer 700, the operation of each part thereof is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the spiking neural network 620 to perform processing in accordance with the program. Communication between the spiking neural network 620 and other devices is performed by the interface 740, which has a communication function and operates under the control of CPU 710. Interaction between the spiking neural network 620 and a user is carried out by the interface 740 including an input device and an output device, presenting information to the user via the output device under the control of the CPU 710, and accepting user operations via the input device.

When the learning device 631 is implemented in the computer 700, the operation of the learning portion 632 is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the learning device 631 to perform processing in accordance with the program. Communication with other devices by the learning device 631 is performed by the interface 740 including a communication function and operating under the control of the CPU 710. Interaction between the learning device 631 and a user is carried out by the interface 740 including an input device and an output device, presenting information to the user via the output device under the control of the CPU 710, and accepting user operations via the input device.

When the spiking neural network 633 is implemented in the computer 700, the operation of each part thereof is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the spiking neural network 633 to perform processing in accordance with the program. Communication between the spiking neural network 633 and other devices is performed by the interface 740, which has a communication function and operates under the control of CPU 710. Interaction between the spiking neural network 633 and a user is carried out by the interface 740 including an input device and an output device, presenting information to the user via the output device under the control of the CPU 710, and accepting user operations via the input device.

Any one or more of the above-mentioned programs may be recorded in the non-volatile recording medium 750. In this case, the interface 740 may read the program from the non-volatile recording medium 750. The CPU 710 may then directly execute the program read by the interface 740, or may temporarily store the program in the main storage device 720 or the auxiliary storage device 730 and then execute it.

In addition, a program for executing all or part of the processing performed by the learning device 100, neural network 200, learning device 610, spiking neural network 620, learning device 631, and spiking neural network 633 may be recorded on a computer-readable recording medium, and the program recorded on this recording medium may be read into a computer system and executed to perform the processing of each part. The term “computer system” herein includes an OS (Operating System) and hardware such as peripheral devices.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing some of the functions described above, and may further be capable of realizing the functions described above in combination with a program already recorded in the computer system.

While preferred embodiments of the invention have been described and illustrated above, it is to be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

As mentioned above, the spiking neural network is disclosed. One type of spiking neural network is a spiking neural network using time-to-first-spike coding that transmits information based on firing times. In a spiking neural network using time-to-first-spike coding, if the proportion of neurons that do not fire is too high, it is thought that the amount of information transmitted will be small, resulting in low estimation accuracy by the neural network. For this reason, it is preferable for neurons to have a relatively high probability of firing.

According to one aspect of the present disclosure, for example, it is expected that neurons in a spiking neural network using time-to-first-spike coding will have a relatively high probability of firing.

A part or all of the above-described embodiments can be described as in the following supplementary notes, but is not limited to the following.

### Supplementary Note 1

A learning device includes a learning means for learning a spiking neural network using time-to-first-spike coding, by using an evaluation function including a predetermined reference time given to each layer of the spiking neural network and an index related to neurons.

### Supplementary Note 2

The learning device according to Supplementary Note 1, wherein the index is the firing time of the neuron.

### Supplementary Note 3

The learning device according to Supplementary Note 2, wherein the learning means learns the spiking neural network using the evaluation function including a sub-expression that shows a better evaluation in a case where the firing time is earlier than the reference time than in a case where the firing time is later than the reference time.

### Supplementary Note 4

The learning device as described in Supplementary Note 3,
wherein one or more hidden layers of the spiking neural network are convolutional layers using spiking neurons, and
the learning means learns the spiking neural network using the evaluation function including a sub-expression that sums up, for all neurons in that layer, sub-expressions that indicate a better evaluation in a case where the firing time is earlier than the reference time than in a case where the firing time is later than the reference time, and then divides the sum by the number of neurons per channel in that layer.

### Supplementary Note 5

The learning device according to Supplementary Note 3 or Supplementary Note 4, wherein the learning means performs learning of the spiking neural network using the evaluation function including a sub-expression that shows a better evaluation in a case where the firing time is earlier than the reference time than in a case where the firing time is later than the reference time, and that indicates a better evaluation as the firing time is closer to the reference time in a case where the firing time is later than the reference time.

### Supplementary Note 6

The learning device according to Supplementary Note 1, wherein the index is the membrane potential of the neurons at the reference time.

### Supplementary Note 7

The learning device according to Supplementary Note 6, wherein the learning means learns the spiking neural network using the evaluation function including a sub-expression that shows a better evaluation a closer the average value of the membrane potential per channel of the hidden layer of the spiking neural network at the reference time is to a firing threshold.

### Supplementary Note 8

The learning device according to Supplementary Note 7, wherein the learning means performs learning of the spiking neural network by mini-batch learning.

### Supplementary Note 9

The learning device according to any one of supplementary notes 1 to 8,
wherein a firing time period during which the firing time of a neuron is transmitted to a next layer is set for each layer of the spiking neural network, and the reference time is set for each layer of the spiking neural network to a time within the firing time period of the layer, and
the learning means performs learning of the spiking neural network by setting the firing time of a neuron that has not fired within the firing time period as the end time of the firing time period or a time that is later than the end time of the firing time period and is determined in advance.

### Supplementary Note 10

The learning device according to any one of supplementary notes 1 to 9, wherein for layers that are the subject of learning of layers of the spiking neural network, a reference time is set for each layer, the reference time being obtained by equally dividing the time from the reference time determined for a first layer in a order of transmission of spike signals of layers that are the subject of learning to the reference time determined for a last layer in the order.

### Supplementary Note 11

The learning device according to any one of supplementary notes 1 to 10,
wherein one or more hidden layers of the spiking neural network are pooling layers that output spike signals according to the timing at which any one of the spike signals included in the window to be pooled first arrives at the hidden layer, and
the learning means performs learning of the spiking neural network while excluding the pooling layer of the hidden layer from the learning target.

### Supplementary Note 12

A spiking neural network, using time-to-first-spike coding, that is learned by using an evaluation function including a predetermined reference time given to each layer of the spiking neural network using the time-to-first-spike coding and an index related to neurons.

### Supplementary Note 13

The spiking neural network according to Supplementary Note 12, wherein the index is the firing time of the neuron.

### Supplementary Note 14

The spiking neural network according to Supplementary Note 13, wherein the evaluation function is the evaluation function including a sub-expression that shows a better evaluation in a case where the firing time is earlier than the reference time than in a case where the firing time is later than the reference time.

### Supplementary Note 15

The spiking neural network according to Supplementary Note 14,
wherein one or more hidden layers of the spiking neural network are convolutional layers using spiking neurons, and
the evaluation function is the evaluation function including a sub-expression that sums up, for all neurons in that layer, sub-expressions that indicate a better evaluation in a case where the firing time is earlier than the reference time than in a case where the firing time is later than the reference time, and then divides the sum by the number of neurons per channel in that layer.

### Supplementary Note 16

The spiking neural network according to Supplementary Note 14 or Supplementary Note 15, wherein the evaluation function is the evaluation function including a sub-expression that shows a better evaluation in a case where the firing time is earlier than the reference time than in a case where the firing time is later than the reference time, and that indicates a better evaluation as the firing time is closer to the reference time in a case where the firing time is later than the reference time.

### Supplementary Note 17

The spiking neural network according to Supplementary Note 12, wherein the index is the membrane potential of the neurons at the reference time.

### Supplementary Note 18

The spiking neural network according to Supplementary Note 17, the evaluation function is the evaluation function including a sub-expression that shows a better evaluation as the average value of the membrane potential per channel of the hidden layer of the spiking neural network at the reference time is closer to a firing threshold.

### Supplementary Note 19

The spiking neural network according to Supplementary Note 18, wherein learning using the evaluation function is performed by mini-batch learning.

### Supplementary Note 20

The spiking neural network according to any one of Supplementary Note 12 to Supplementary Note 19,
wherein a firing time period during which the firing time of a neuron is transmitted to a next layer is set for each layer of the spiking neural network, and the reference time is set for each layer of the spiking neural network to a time within the firing time period of the layer, and
in learning using the evaluation function, the firing time of a neuron that has not fired within the firing time period is set to the end time of the firing time period or a time that is later than the end time and is determined in advance.

### Supplementary Note 21

The spiking neural network according to any one of Supplementary Note 12 to Supplementary Note 20, wherein for layers that are the subject of learning of layers of the spiking neural network, a reference time is set for each layer, the reference time being obtained by equally dividing the time from the reference time determined for a first layer in an order of transmission of spike signals of layers that are the subject of learning to the reference time determined for a last layer in the order.

### Supplementary Note 22

The spiking neural network according to any one of Supplementary Note 12 to Supplementary Note 21,
wherein one or more hidden layers of the spiking neural network are pooling layers that output spike signals according to the timing at which any one of the spike signals included in the window to be pooled first arrives at the hidden layer, and
the learning using the evaluation function is performed while excluding the pooling layer of the hidden layer from the learning target.

### Supplementary Note 23

A learning system comprising:
a spiking neural network using time-to-first-spike coding; and
a learning device,
wherein the learning device comprises a learning means for learning the spiking neural network using an evaluation function including a predetermined reference time given to each layer of the spiking neural network and an index related to neurons.

### Supplementary Note 24

The learning system according to Supplementary Note 23, wherein the index is the firing time of the neuron.

### Supplementary Note 25

The learning system according to Supplementary Note 24, wherein the learning means performs learning of the spiking neural network using the evaluation function including a sub-expression that shows a better evaluation in a case where the firing time is earlier than the reference time than in a case where the firing time is later than the reference time.

### Supplementary Note 26

The learning system according to Supplementary Note 25,
wherein one or more hidden layers of the spiking neural network are convolutional layers using spiking neurons, and
the learning means performs learning of the spiking neural network using the evaluation function including a sub-expression that sums up, for all neurons in that layer, sub-expressions that indicate a better evaluation in a case where the firing time is earlier than the reference time than in a case where the firing time is later than the reference time, and then divides the sum by the number of neurons per channel in that layer.

### Supplementary Note 27

The learning system according to Supplementary Note 25 or Supplementary Note 26, wherein the learning means performs learning of the spiking neural network using the evaluation function including a sub-expression that shows a better evaluation in a case where the firing time is earlier than the reference time than in a case where the firing time is later than the reference time, and that indicates a better evaluation as the firing time is closer to the reference time in a case where the firing time is later than the reference time.

### Supplementary Note 28

The learning system according to Supplementary Note 23, wherein the index is the membrane potential of the neurons at the reference time.

### Supplementary Note 29

The learning system according to Supplementary Note 28, wherein the learning means performs learning of the spiking neural network using the evaluation function including a sub-expression that shows a better evaluation a closer the average value of the membrane potential per channel of the hidden layer of the spiking neural network at the reference time is to a firing threshold.

### Supplementary Note 30

The learning system according to Supplementary Note 29, wherein the learning means performs learning of the spiking neural network by mini-batch learning.

### Supplementary Note 31

The learning system according to any one of supplementary notes 23 to 30,
wherein a firing time period during which the firing time of a neuron is transmitted to a next layer is set for each layer of the spiking neural network, and the reference time is set for each layer of the spiking neural network to a time within the firing time period of the layer, and
the learning means performs learning of the spiking neural network by setting the firing time of a neuron that has not fired within the firing time period as the end time of the firing time period or a time that is later than the end time of the firing time period and is determined in advance.

### Supplementary Note 32

The learning system according to any one of supplementary notes 23 to 31, wherein for layers that are the subject of learning of layers of the spiking neural network, a reference time is set for each layer, the reference time being obtained by equally dividing the time from the reference time determined for a first layer in an order of transmission of spike signals of layers that are the subject of learning to the reference time determined for a last layer in the order.

### Supplementary Note 33

The learning system according to any one of supplementary notes 23 to 32,
wherein one or more hidden layers of the spiking neural network are pooling layers that output spike signals according to the timing at which any one of the spike signals included in the window to be pooled first arrives at the hidden layer, and
the learning means performs learning of the spiking neural network while excluding the pooling layer of the hidden layer from the learning target.

### Supplementary Note 34

A learning method comprising:
learning, by a computer, a spiking neural network using time-to-first-spike coding, by using an evaluation function including a predetermined reference time given to each layer of the spiking neural network and an index related to neurons.

### Supplementary Note 35

The learning method according to Supplementary Note 34, wherein the index is the firing time of the neuron.

### Supplementary Note 36

The learning method according to Supplementary Note 35, wherein the learning includes learning the spiking neural network using the evaluation function including a sub-expression that shows a better evaluation in a case where the firing time is earlier than the reference time than in a case where the firing time is later than the reference time.

### Supplementary Note 37

The learning method according to Supplementary Note 36,
wherein one or more hidden layers of the spiking neural network are convolutional layers using spiking neurons, and
the learning includes learning the spiking neural network using the evaluation function including a sub-expression that sums up, for all neurons in that layer, sub-expressions that indicate a better evaluation in a case where the firing time is earlier than the reference time than in a case where the firing time is later than the reference time, and then divides the sum by the number of neurons per channel in that layer.

### Supplementary Note 38

The learning method according to Supplementary Note 36 or Supplementary Note 37, wherein the learning includes performing learning of the spiking neural network using the evaluation function including a sub-expression that shows a better evaluation in a case where the firing time is earlier than the reference time than in a case where the firing time is later than the reference time, and that indicates a better evaluation as the firing time is closer to the reference time in a case where the firing time is later than the reference time.

### Supplementary Note 39

The learning method according to Supplementary Note 34, wherein the index is the membrane potential of the neurons at the reference time.

### Supplementary Note 40

The learning method according to Supplementary Note 39, wherein the learning includes performing learning of the spiking neural network using the evaluation function including a sub-expression that shows a better evaluation a closer the average value of the membrane potential per channel of the hidden layer of the spiking neural network at the reference time is to a firing threshold.

### Supplementary Note 41

The learning method according to Supplementary Note 40, wherein the learning includes performing learning of the spiking neural network by mini-batch learning.

### Supplementary Note 42

The learning method according to any one of supplementary notes 34 to 41,
wherein a firing time period during which the firing time of a neuron is transmitted to a next layer is set for each layer of the spiking neural network, and the reference time is set for each layer of the spiking neural network to a time within the firing time period of the layer, and
the learning includes performing learning of the spiking neural network by setting the firing time of a neuron that has not fired within the firing time period as the end time of the firing time period or a time that is later than the end time of the firing time period and is determined in advance.

### Supplementary Note 43

The learning method according to any one of supplementary notes 34 to 42, wherein for layers that are the subject of learning of layers of the spiking neural network, a reference time is set for each layer, the reference time being obtained by equally dividing the time from the reference time determined for a first layer in an order of transmission of spike signals of layers that are the subject of learning to the reference time determined for a last layer in the order.

### Supplementary Note 44

The learning method according to any one of supplementary notes 34 to 43,
wherein one or more hidden layers of the spiking neural network are pooling layers that output spike signals according to the timing at which any one of the spike signals included in the window to be pooled first arrives at the hidden layer, and
the learning includes performing learning of the spiking neural network while excluding the pooling layer of the hidden layer from the learning target.

### Supplementary Note 45

A program that causes a computer to execute learning a spiking neural network using time-to-first-spike coding, by using an evaluation function including a predetermined reference time given to each layer of the spiking neural network and an index related to neurons.

### Supplementary Note 46

The program according to Supplementary Note 45, wherein the index is the firing time of the neuron.

### Supplementary Note 47

The program according to Supplementary Note 46, wherein in the learning, the program causes the computer to execute learning of the spiking neural network using the evaluation function including a sub-expression that shows a better evaluation in a case where the firing time is earlier than the reference time than in a case where the firing time is later than the reference time.

### Supplementary Note 48

The program according to Supplementary Note 47,
wherein one or more hidden layers of the spiking neural network are convolutional layers using spiking neurons, and
in the learning, the program causes the computer to execute learning of the spiking neural network using the evaluation function including a sub-expression that sums up, for all neurons in that layer, sub-expressions that indicate a better evaluation in a case where the firing time is earlier than the reference time than in a case where the firing time is later than the reference time, and then divides the sum by the number of neurons per channel in that layer.

### Supplementary Note 49

The program according to Supplementary Note 47 or Supplementary Note 48, wherein in the learning, the program causes the computer to execute learning of the spiking neural network using the evaluation function including a sub-expression that shows a better evaluation in a case where the firing time is earlier than the reference time than in a case where the firing time is later than the reference time, and that indicates a better evaluation as the firing time is closer to the reference time in a case where the firing time is later than the reference time.

### Supplementary Note 50

The program according to Supplementary Note 45, wherein the index is the membrane potential of the neurons at the reference time.

### Supplementary Note 51

The program according to Supplementary Note 50, wherein in the learning, the program causes the computer to execute learning of the spiking neural network using the evaluation function including a sub-expression that shows a better evaluation a closer the average value of the membrane potential per channel of the hidden layer of the spiking neural network at the reference time is to a firing threshold.

### Supplementary Note 52

The program according to Supplementary Note 51, wherein in the learning, the program causes the computer to perform learning of the spiking neural network by mini-batch learning.

### Supplementary Note 53

The program according to any one of supplementary notes 45 to 52,
wherein a firing time period during which the firing time of a neuron is transmitted to a next layer is set for each layer of the spiking neural network, and the reference time is set for each layer of the spiking neural network to a time within the firing time period of the layer, and
in the learning, the program causes the computer to execute learning of the spiking neural network by setting the firing time of a neuron that has not fired within the firing time period as the end time of the firing time period or a time that is later than the end time of the firing time period and is determined in advance.

### Supplementary Note 54

The program according to any one of supplementary notes 45 to 53, wherein for layers that are the subject of learning of layers of the spiking neural network, a reference time is set for each layer, the reference time being obtained by equally dividing the time from the reference time determined for a first layer in an order of transmission of spike signals of layers that are the subject of learning to the reference time determined for a last layer in the order.

### Supplementary Note 55

The program according to any one of supplementary notes 45 to 54, wherein one or more hidden layers of the spiking neural network are pooling layers that output spike signals according to the timing at which any one of the spike signals included in the window to be pooled first arrives at the hidden layer, and
in the learning, the program causes the computer to execute learning of the spiking neural network while excluding the pooling layer of the hidden layer from the learning target.

What is claimed is:

1. A learning device comprising:
at least one memory configured to store instructions; and
at least one processor configured to execute the instructions to:
learn a spiking neural network using time-to-first-spike coding, by using an evaluation function including a predetermined reference time given to each layer of the spiking neural network and an index related to neurons.

2. The learning device according to claim 1,
wherein the index is the firing time of the neuron.

3. The learning device according to claim 2,
wherein the at least one processor is configured to execute the instructions to learn the spiking neural network using the evaluation function including a sub-expression that shows a better evaluation in a case where the firing time is earlier than the reference time than in a case where the firing time is later than the reference time.

4. The learning device according to claim 1,
wherein the index is the membrane potential of the neurons at the reference time.

5. The learning device according to claim 4,
wherein the at least one processor is configured to execute the instructions to learn the spiking neural network using the evaluation function including a sub-expression that shows a better evaluation a closer the average value of the membrane potential per channel of the hidden layer of the spiking neural network at the reference time is to a firing threshold.

6. The learning device according to claim 1,
wherein a firing time period during which the firing time of a neuron is transmitted to a next layer is set for each layer of the spiking neural network, and the reference time is set for each layer of the spiking neural network to a time within the firing time period of the layer, and
the at least one processor is configured to execute the instructions to learn the spiking neural network by setting the firing time of a neuron that has not fired within the firing time period as the end time of the firing time period or a time that is later than the end time of the firing time period and is determined in advance.

7. The learning device according to claim 1, wherein
for layers that are the subject of learning of layers of the spiking neural network, a reference time is set for each layer, the reference time being obtained by equally dividing the time from the reference time determined for a first layer in an order of transmission of spike signals of layers that are the subject of learning to the reference time determined for a last layer in the order.

8. A learning system comprising:
a spiking neural network using time-to-first-spike coding; and
a learning device,
wherein the learning device comprises:
at least one memory configured to store instructions; and
at least one processor configured to execute the instructions to:
learn the spiking neural network using an evaluation function including a predetermined reference time given to each layer of the spiking neural network and an index related to neurons.

9. A learning method comprising:
learning, by a computer, a spiking neural network using time-to-first-spike coding, by using an evaluation function including a predetermined reference time given to each layer of the spiking neural network and an index related to neurons.
